(19) United States
(12) Patent Application Publication
(10) Pub. No.: US 2025/0172767 A1
(43) Pub. Date: May 29, 2025

(54) WAFER-SCALE WAVEGUIDES FOR INTEGRATED TWO-DIMENSIONAL PHOTONICS

(71) Applicant: The University of Chicago, Chicago, IL (US)

(72) Inventors: Jiwoong Park, Chicago, IL (US); Hanyu Hong, Chicago, IL (US); Myungjae Lee, Chicago, IL (US)

(73) Assignee: The University of Chicago, Chicago, IL (US)

(21) Appl. No.: 18/799,797

(22) Filed: Aug. 9, 2024

Related U.S. Application Data
(60) Provisional application No. 63/554,520, filed on Feb. 16, 2024.
(60) Provisional application No. 63/518,444, filed on Aug. 9, 2023.

(51) Int. Cl. G02B 6/42

(52) U.S. Cl. CPC G02B 6/4206; G02B 6/42

(57) ABSTRACT

Systems and methods for generating and manipulating a guided electromagnetic wave in a waveguide are provided. The optical system includes a waveguide, such as a two-dimensional waveguide, and an optical element disposed adjacent the surface of the waveguide. To generate the guided electromagnetic wave, a converging laser beam is generated and coupled to the waveguide by steering the converging laser beam towards an edge of the waveguide and with a beam center trajectory approximately parallel to a surface of the waveguide.

### RELATED APPLICATIONS

This application claims the benefit under 35 U.S.C. § 119 of U.S. Provisional Patent Application No. 63/518,444, filed Aug. 9, 2023, titled “Wafer-Scale Waveguides for Integrated Two-Dimensional Photonics,” and of U.S. Provisional Application No. 63/554,520, filed Feb. 16, 2024, titled “Wafer-Scale Waveguides for Integrated Two-Dimensional Photonics,” each of which is incorporated herein by reference in its entirety.

### GOVERNMENT SPONSORSHIP

This invention was made with government support under FA9550-16-1-0347, FA9550-21-1-0323, and FA9550-18-1-0480 awarded by the Air Force Office of Scientific Research, and 2011854, and 1719875 awarded by the National Science Foundation. The government has certain rights in the invention.

### BACKGROUND

### Field

The aspects described herein relate to photonic waveguides.

### Related Art

A waveguide is a physical structure that guides the transmission of waves by restricting the transmission of energy within a particular geometry. Optical waveguides are physical structures that guide electromagnetic waves in the optical spectrum. Common optical waveguides include optical fiber waveguides, dielectric waveguides (e.g., made of plastic, glass, or other dielectric materials), and liquid waveguides.

### BRIEF SUMMARY

Some embodiments are directed to an optical device, comprising: a waveguide; and an optical element disposed adjacent a surface of the waveguide such that the optical element can alter, when the optical device is in operation, an electromagnetic wave guided by the waveguide.

In some embodiments, the optical element comprises a dielectric film.

In some embodiments, the dielectric film comprises a patterned photoresist.

In some embodiments, the dielectric film comprises a prism, a convex lens, or a concave lens.

In some embodiments, the optical element comprises a metallic film.

In some embodiments, the metallic film comprises a gold film.

In some embodiments, the metallic film comprises a slit or a grating.

In some embodiments, the waveguide comprises a thin film material.

In some embodiments, the thin film material comprises at least one monolayer.

In some embodiments, the at least one monolayer comprises between one and three monolayers.

In some embodiments, the thin film material comprises a van der Waals material.

In some embodiments, the thin film material comprises a transition metal dichalcogenide.

In some embodiments, the thin film material comprises MoS₂.

In some embodiments, the optical element comprises a rectangular region of the waveguide lacking the thin film material.

In some embodiments, the rectangular region is arranged having one corner of the rectangular region disposed in a path of the electromagnetic wave guided by the waveguide.

In some embodiments, the optical element is disposed out-of-plane relative to a plane in which a surface of the waveguide is disposed.

Some embodiments are directed to a method of operating an optical device, the optical device comprising a waveguide, the method comprising: generating a guided electromagnetic wave by: generating a converging laser beam; and coupling the converging laser beam to the waveguide by steering the converging laser beam towards an edge of the waveguide and with a beam center trajectory approximately parallel to a surface of the waveguide.

In some embodiments, generating the converging laser beam comprises generating a laser beam having a numerical aperture in a range from 0.01 to 0.6.

In some embodiments, generating the converging laser beam comprises generating a laser beam having a focused beam width in a range from 2 μm to 10 μm.

In some embodiments, generating the converging laser beam comprises generating a laser beam having a wavelength in a range from 500 nm to 900 nm.

In some embodiments, steering the converging laser beam towards the edge of the waveguide comprises steering the converging laser beam towards an edge of a thin film material.

In some embodiments, steering the converging laser beam towards the edge of a thin film material comprises steering the converging laser beam towards an edge of a thin film material comprising at least one monolayer.

In some embodiments, steering the converging laser beam towards the edge of the waveguide comprises steering the converging laser beam towards an edge of a thin film material comprising a van der Waals material.

In some embodiments, steering the converging laser beam towards the edge of the waveguide comprises steering the converging laser beam towards an edge of a thin film material comprising a transition metal dichalcogenide.

### BRIEF DESCRIPTION OF DRAWINGS

Various aspects and embodiments will be described with reference to the following figures. It should be appreciated that the figures are not drawn to scale. In the drawings, each identical or nearly identical component that is illustrated in various figures is represented by a like numeral. For purposes of clarity, not every component may be labeled in every drawing.

FIG. 1A is a schematic diagram of an example of an optical device for generating a guided electromagnetic wave in a waveguide, in accordance with some embodiments of the technology described herein.

FIG. 1B depicts an example of an optical device for generating a guided electromagnetic wave in a waveguide including a polydimethylsiloxane (PDMS) substrate, in accordance with some embodiments of the technology described herein.

FIG. 1C is a schematic diagram of an example of an optical system for coupling light to an optical device, in accordance with some embodiments of the technology described herein.

FIG. 1D is a microscopy image taken in an end-face imaging configuration in the optical system of FIG. 1C without the presence of a thin film waveguide, in accordance with some embodiments of the technology described herein.

FIG. 1E is a microscopy image taken in an end-face imaging configuration in the optical system of FIG. 1C with the presence of a thin film waveguide, in accordance with some embodiments of the technology described herein.

FIG. 2A is a plot showing simulated transverse line profiles of guided modes in multilayer waveguides for a range of layers between one layer and five layers, in accordance with some embodiments of the technology described herein.

FIG. 2B is a plot showing simulated confinement factors as a function of the number of layers in a thin film waveguide, in accordance with some embodiments of the technology described herein.

FIG. 3A shows a film-surface microscopy image of a guided electromagnetic wave in an MoS₂ thin film waveguide, the image acquired by collecting dark-field signals at λ=720 nm, in accordance with some embodiments of the technology described herein.

FIG. 3B shows dark-field microscopy images of a monolayer MoS₂ thin film waveguide as a function of wavelength, in accordance with some embodiments of the technology described herein.

FIG. 3C is a plot showing a rate of dark-field signal decays as a function of wavelength for the monolayer MoS₂ thin film waveguide of FIG. 3B, in accordance with some embodiments of the technology described herein.

FIG. 3D shows dark-field microscopy images of a MoS₂ thin film having two layers as a function of wavelength, in accordance with some embodiments of the technology described herein.

FIG. 3E shows dark-field microscopy images of a MoS₂ thin film having three layers as a function of wavelength, in accordance with some embodiments of the technology described herein.

FIG. 3F shows intensity profiles of dark-field images as a function of propagation distance for MoS₂ thin films having one, two, and three layers, in accordance with some embodiments of the technology described herein.

FIG. 3G shows cross-sectional beam profiles without (top) and with (bottom) the presence of an MoS₂ thin film device, in accordance with some embodiments of the technology described herein.

FIGS. 3H and 3I show microscopy images taken in an end-facing configuration for TE and TM polarizations, respectively, in accordance with some embodiments of the technology described herein.

FIG. 3J shows microscopy images taken in a top-down configuration for TE (top) and TM (bottom) polarizations, in accordance with some embodiments of the technology described herein.

FIG. 4A is a plot showing measured intensity of a guided wave in a monolayer MoS₂ thin film measured as a function of incident angle, in accordance with some embodiments of the technology described herein.

FIG. 4B shows a schematic diagram of a laser beam and thin film waveguide when the thin film is inside the symmetric index (Δn/n₀≈0) with near-zero tilting angle to the incident beam (θ≈0) and a corresponding dark-field microscopy image of a monolayer MoS₂ thin film, in accordance with some embodiments of the technology described herein.

FIG. 4C shows a schematic diagram of a laser beam and thin film waveguide when the thin film is inside the asymmetric index (Δn/n₀≈0.9%) with θ≈0 and a corresponding dark-field microscopy image of a monolayer MoS₂ thin film, in accordance with some embodiments of the technology described herein.

FIG. 4D shows a schematic diagram of a laser beam and thin film waveguide when the thin film is inside the symmetric index (Δn/n₀≈0) and there is a tilting angle thin film relative to the beam path of the laser beam (θ=1.3°) and a corresponding dark-field microscopy image of a monolayer MoS₂ thin film, in accordance with some embodiments of the technology described herein.

FIG. 4E shows a schematic diagram of a laser beam and thin film waveguide when the thin film is inside the asymmetric index (Δn/n₀≈0.9%) and there is a tilting angle thin film relative to the beam path of the laser beam (θ=1.3°) and a corresponding dark-field microscopy image of a monolayer MoS₂ thin film, in accordance with some embodiments of the technology described herein.

FIG. 5 is a flowchart describing a process 500 for operating an optical device, in accordance with some embodiments of the technology described herein.

FIG. 6A is a schematic diagram of an example of an optical device for generating a guided electromagnetic wave in a waveguide and including an optical element, in accordance with some embodiments of the technology described herein.

FIG. 6B is a diagram illustrating a process for manufacturing the optical device of FIG. 6A, in accordance with some embodiments of the technology described herein.

FIG. 6C shows a schematic diagram of an optical element that is a prism disposed on a thin film waveguide and a corresponding dark-field microscopy image of the interaction of the guided wave with the optical element, in accordance with some embodiments of the technology described herein.

FIG. 6D shows a schematic diagram of an optical element that is a convex lens disposed on a thin film waveguide and a corresponding dark-field microscopy image of the interaction of the guided wave with the optical element, in accordance with some embodiments of the technology described herein.

FIG. 6E shows a schematic diagram of an optical element that is a concave lens disposed on a thin film waveguide and a corresponding dark-field microscopy image of the interaction of the guided wave with the optical element, in accordance with some embodiments of the technology described herein.

FIG. 6F is a scanning electron microscope (SEM) image of examples of optical elements including concave and convex lenses, in accordance with some embodiments of the technology described herein.

FIG. 6G is an optical micrograph of aligned and stacked optical elements, in accordance with some embodiments of the technology described herein.

FIG. 6H is a dark-field microscopy image of guided waves interacting with an optical element that is a concave lens, in accordance with some embodiments of the technology described herein.

FIG. 6I is a plot of the intensity profile of the image of FIG. 6H as a function of propagation distance, in accordance with some embodiments of the technology described herein.

FIG. 6J shows a schematic diagram of an optical element that is a slit disposed on a thin film waveguide and a corresponding dark-field microscopy image of the interaction of the guided wave with the optical element, in accordance with some embodiments of the technology described herein.

FIG. 6K shows a schematic diagram of an optical element that is a grating disposed on a thin film waveguide and a corresponding dark-field microscopy image of the interaction of the guided wave with the optical element, in accordance with some embodiments of the technology described herein.

FIG. 6L is an optical microscope image of a metallic grating, in accordance with some embodiments of the technology described herein.

FIG. 6M is an SEM image of a metallic grating on a monolayer MoS₂ thin film waveguide, in accordance with some embodiments of the technology described herein.

FIGS. 6N and 6O are illustrations and simulations of the index modulation of guided modes caused by a dielectric thin film and a metallic film, respectively, in accordance with some embodiments of the technology described herein.

FIG. 6P shows a schematic diagram of an optical element delivering a designed wavefront to the thin film waveguide and a corresponding dark-field microscopy image of the interaction of the wavefront with the thin film waveguide, in accordance with some embodiments of the technology described herein.

FIG. 7A is a schematic diagram of an example of an optical device for generating a guided electromagnetic wave across interconnected waveguides separated by a distance, in accordance with some embodiments of the technology described herein.

FIG. 7B are dark-field microscopy images of guided waves transported between waveguides separated by various distances, in accordance with some embodiments of the technology described herein.

FIG. 7C is a plot of interconnection loss as a function of interconnection distance as shown in FIG. 7B, in accordance with some embodiments of the technology described herein.

FIG. 7D shows schematic diagrams of three interconnection geometries and corresponding end-face images, in accordance with some embodiments of the technology described herein.

FIG. 7E is a plot showing peak intensity changes for different values of distance for free waves and recoupled waves, in accordance with some embodiments of the technology described herein.

FIG. 8A is a schematic diagram of an example of an optical device for splitting a guided electromagnetic wave, in accordance with some embodiments of the technology described herein.

FIG. 8B shows dark-field microscopy images of split guided electromagnetic waves, in accordance with some embodiments of the technology described herein.

FIG. 9A is a dark-field microscopy image of the propagation of a guided electromagnetic wave across a region without dielectric thin film that is tilted relative to a direction perpendicular to the direction of transmission of the guided electromagnetic wave.

FIG. 9B is a dark-field microscopy image of the propagation of a guided electromagnetic wave across a region that is tilted relative to a direction perpendicular to the direction of transmission of the guided electromagnetic wave, the region having areas without the thin film waveguide material and areas having the thin film waveguide material.

FIG. 10A is a schematic diagram of an example of an optical device for modulation of a guided electromagnetic wave, in accordance with some embodiments of the technology described herein.

FIG. 10B shows dark-field microscopy images of modulated guided electromagnetic waves, in accordance with some embodiments of the technology described herein.

### DETAILED DESCRIPTION

Semiconductor photonic devices enable efficient optical communication but conventionally rely on group III-V semiconductor materials such as gallium arsenide (GaAs). These materials have limited capacity for integration with complementary metal-oxide-semiconductor (CMOS) circuitry as they are compatible with only select substrate materials, are bulky, and are challenging to engineer with respect to tuning the properties of the material. In contrast, van der Waals (vdW) materials, such as graphene and transition metal dichalcogenides (TMDs), are two-dimensional semiconducting materials that offer compact, tunable, versatile, and energy-efficient platforms for realizing photonic integrated circuitry.

Thin film waveguides that can confine, direct, and modulate light waves on chip are important for the implementation of photonic technologies. However, because the optical fields confined by thin film waveguides are located in the interior of such waveguides, integration of these thin film waveguides with multiple photonic components made of distinct materials requires careful tuning of each components' dimensions (e.g., the characteristic size, d), optical properties (e.g., the refractive index, n), and operation wavelengths (λ) to maintain the ratio nd/λ at relatively similar values (e.g., at or near unity) throughout the photonic device. One challenge in integrated photonics is to develop a photonic architecture that is unaffected by such spectral and materials constraints—a particularly challenging goal for waveguides with fixed dimensions such as two-dimensional waveguides.

The efficient large-scale generation and control of photonic modes guided by vdW materials remains a challenge despite their potential for on-chip photonic circuitry. Although vdW materials have been used as waveguides, for example, in studies of surface polaritons or exciton-polariton waves, their use as waveguides has been limited by an unsuitable geometry for integration with other optical components and relatively short propagation lengths. The inventors have recognized and appreciated that monolayers or stacked monolayers of certain vdW materials (e.g., TMDs) can act as two-dimensional waveguides (e.g., δ waveguides) to guide visible and near-infrared light over millimeter-scale distances with low loss and an efficient in-coupling. The extreme thinness provides a light-trapping mechanism analogous to a δ-potential well in quantum mechanics and enables the guided waves that are essentially a plane wave freely propagating along the in-plane, but confined along the out-of-plane, direction of the waveguide.

The inventors have further recognized and appreciated that thin film waveguides (e.g., those based on vdW materials) would be more successfully integrated with other photonic components given a means to manipulate the guided wave. For example, it may be desirable in some photonic architectures to split, focus, bend, refract, or otherwise manipulate the guided wave as it propagates across a thin film waveguide. Accordingly, the inventors have developed integrated components (e.g., dielectric or metal components or patterning of the thin film waveguide material) configured to manipulate guided waves propagating in thin film waveguides.

In some embodiments, an optical device is provided including a waveguide and an optical element disposed adjacent to a surface of the waveguide. The waveguide is, for example, a thin film material configured to guide electromagnetic waves (i.e., to act as a waveguide). The thin film material may have a thickness in a range from 0.5 nm to 3 nm such that the waveguide is a two-dimensional waveguide or δ waveguide. In some embodiments, the thin film material may be a material formed out of at least one monolayer (e.g., a single layer material having a single layer of atoms in a two-dimensional arrangement), between one and three atomic monolayers, and/or between one and five atomic monolayers. In some embodiments, the thin film material is a vdW material. As one non-limiting example, the thin film material is a TMD, including but not limited to MoS₂, TiSe₂, MoSe₂, and/or WSe₂. As another non-limiting example, the thin film material is a two-dimensional material including but not limited to graphene, silicene, graphene-silicene, plumbene, and/or wide band gap materials (e.g., hexagonal boron nitride).

In some embodiments, the optical element is disposed adjacent to (e.g., disposed on, next to, or in) a surface of the waveguide. In some embodiments, the optical element is disposed above or below a plane of the waveguide, such that the optical element is out-of-plane relative to the plane of the waveguide. In some embodiments, the optical element may be disposed above or below a plan of the waveguide and spaced apart from the planar surface of the waveguide by a distance configured to permit the optical element to interact with propagating guided modes in the waveguide. In some embodiments, the optical element is configured to alter, when the optical device is in operation, the electromagnetic wave guided by the waveguide.

In some embodiments, the optical element is formed of a dielectric film disposed on a surface of the waveguide. As one non-limiting example, the dielectric film is a polymer material (e.g., a photoresist) which has been shaped and/or patterned to form the optical element. The dielectric film may have a thickness on the order of microns (e.g., in a range from 1 μm to 5 μm). For example, the optical element may be a lens configured to focus (e.g., a convex lens) or defocus (e.g., a concave lens) the guided wave. As another example, the optical element may be a prism configured to bend the guided wave (e.g., to change the direction of propagation).

In some embodiments, the optical element is formed of a metallic film disposed on a surface of the waveguide. The metallic film may have a thickness on the order of nanometers (e.g., in a range from 2 nm to 10 nm) or on the order of microns (e.g., in a range from 1 μm to 5 μm). As one non-limiting example, the optical element may be formed of a gold film. For example, the optical element may be a metallic film arranged as a slit configured to narrow a width of the propagating wave. As another example, the optical element may be a metallic film arranged as a grating configured to refract the propagating wave.

In some embodiments, the optical element is formed by a region of the waveguide lacking the thin film material. For example, the optical element may be formed by removing a portion of the thin film material (e.g., by etching or by masking the region during deposition of the thin film material). As one non-limiting example, the region may be a rectangular region. The rectangular region may be arranged so that one corner of the rectangular region is disposed in a path of the electromagnetic wave guided by the waveguide. During operation of the optical device, the optical element may be configured to split the guided electromagnetic wave into two guided electromagnetic waves.

The inventors have recognized and appreciated that another challenge to the integration of thin film waveguides (e.g., vdW material waveguides) with other photonic components is the ability to efficiently couple light into and out of thin film waveguide structures. Accordingly, the inventors have developed techniques for coupling external light sources to thin film waveguides, thereby enabling efficient optical coupling to thin film waveguides. In some embodiments, optically coupling an external light source to a thin film waveguide includes generating a converging laser beam. As one non-limiting example, the converging laser beam may be generated by providing a coherent laser beam (e.g., having a wavelength in a range from 500 nm to 900 nm) to a single-mode optical fiber for output to a series of relay optics configured to manipulate and collimate the laser beam. For example, the relay optics may be arranged based on an achromatic 4f configuration. The resulting converging laser beam may be generated with a numerical aperture (NA) in a range from 0.01 to 0.6, in a range of 0.05 to 0.3, or in any suitable range within those ranges. Additionally, the converging laser beam may be generated with a focused beam width (i.e., at the focal point of the laser beam) in a range from 1.3 μm to 550 μm, in a range from 1.3 μm to 100 μm, in a range from 2 μm to 10 μm, or in any suitable range within those ranges.

In some embodiments, optically coupling the external light source to the thin film waveguide further includes steering the converging laser beam towards an edge of the thin film waveguide. The converging laser beam is steered towards an edge of the thin film waveguide with a beam center trajectory approximately parallel to a surface of the waveguide. For example, steering the converging laser beam towards an edge of the thin film waveguide may include steering the converging laser beam towards an edge of a thin film material as described herein, including but not limited to a vdW material and/or a TMD. In some embodiments, the tilting angle between the converging laser beam and the surface of the waveguide is less than the angle of the beam divergence of the converging laser beam.

### I. Thin Film Waveguides

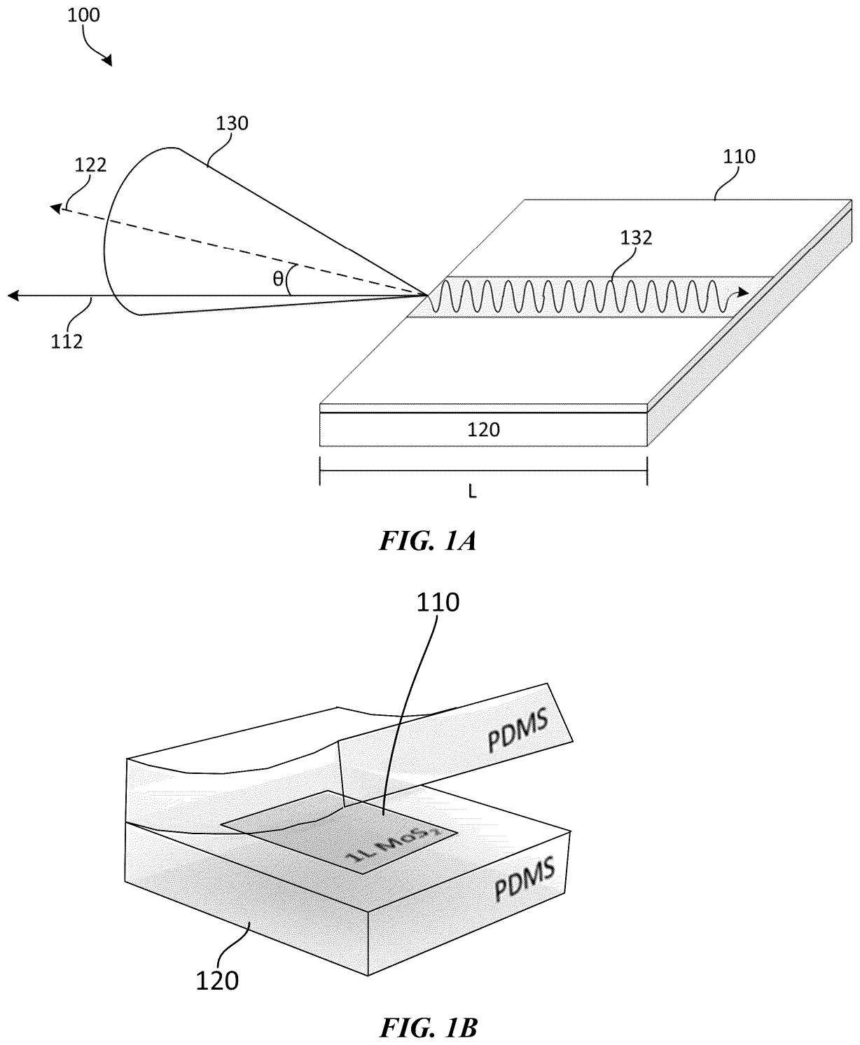

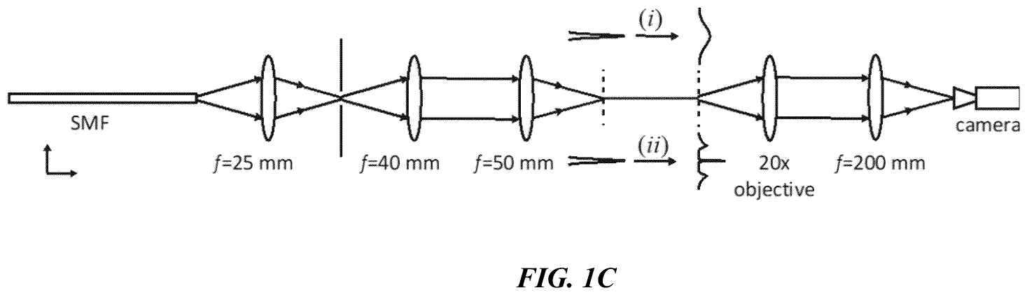

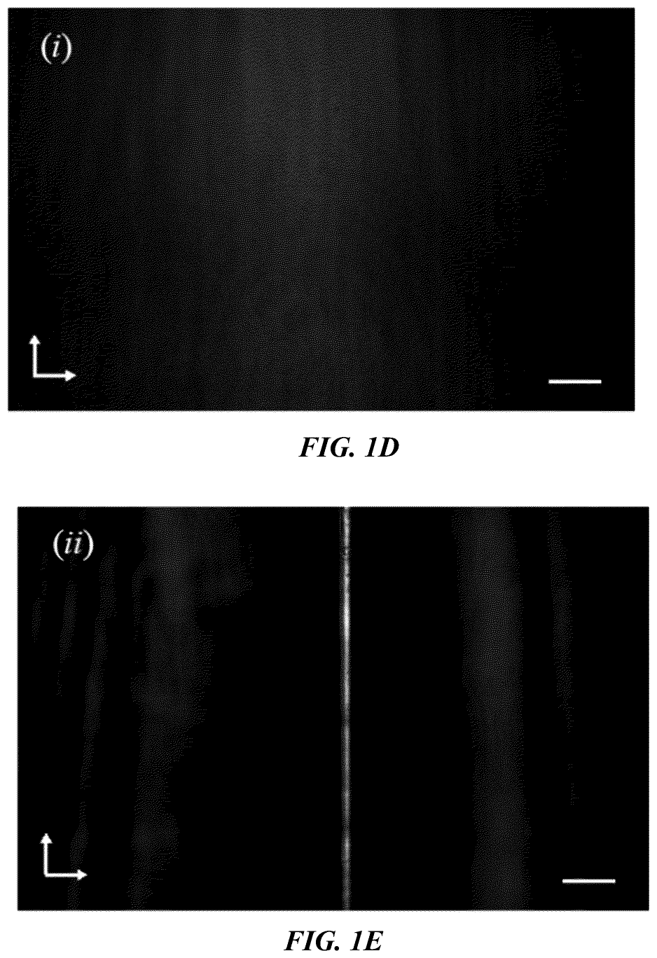

FIG. 1A is a schematic diagram of an example of an optical device 100 for generating a guided electromagnetic wave in a waveguide, in accordance with some embodiments of the technology described herein. The optical device 100 includes a waveguide 110 disposed on a substrate 120. During operation of the optical device 100, a laser beam 130 is optically coupled to the waveguide 110 to generate guided electromagnetic wave 132.

In some embodiments, the waveguide 110 is, for example, a δ waveguide or a two-dimensional waveguide. The waveguide 110 may be formed of a thin film material configured to guide electromagnetic waves and having a length, L, on the order of millimeters. The thin film material may be a material formed out of at least one atomic monolayer (e.g., a single layer material having a single layer of atoms in a two-dimensional arrangement), between one and three atomic monolayers, and/or between one and five atomic monolayers. The thin film material may have a total thickness in a range from 0.5 nm to 3 nm such that the waveguide is a two-dimensional waveguide or δ waveguide. In some embodiments, the thin film material comprises (e.g., is made of) a vdW material. As one non-limiting example, the thin film material comprises a TMD, including but not limited to MoS₂, TiSe₂, MoSe₂, and/or WSe₂. As another non-limiting example, the thin film material comprises a two-dimensional material including but not limited to graphene, silicene, graphene-silicene, and/or plumbene.

In some embodiments, the waveguide 110 may be a thin film formed of a monolayer of MoS₂ (e.g., having a thickness of approximate 0.6 nm and bandgap E_{g} of approximately 1.9 eV) surrounded by an optically homogeneous polymer packaging (e.g., formed of polydimethylsiloxane (PDMS)), as depicted in FIG. 1B. To fabricate the optical device 100, a continuous wafer-scale monolayer film of the thin film material may be grown on a growth substrate (e.g., fused silica) using metal-organic chemical vapor deposition (MOCVD). The growth substrate may be, for example, double-side polished fused silica (e.g., Corning HPFS 7980) having less than 0.7-nm local surface roughness and less than 2-μm total thickness variation). Multilayer (e.g., two, three, four, or five layer) thin films may be assembled by using a layer-by-layer vacuum stacking approach assisted by sacrificial layers of polymethyl methacrylate. After growing the thin film on the growth substrate, the growth substrate may be cleaved at two opposite sides to make clean sidewalls suitable for optical coupling to the laser beam 130.

In some embodiments, after growth of the thin film on the growth substrate, the thin film may then be delaminated from the growth substrate and transferred to the substrate 120. In some embodiments, the substrate 120 may be a cured silicone elastomer material (e.g., Dow Sylgard-184 PDMS). For the transfer from the growth substrate to the substrate 120, an elastomer block may be directly placed on top of the thin film, and the supporting growth substrate may be etched away using a KOH solution (˜1 M). After the thin film is released from the growth substrate, the sample is flipped over and liquid PDMS may then be cast on top of the thin film to encapsulate the waveguide 110 to provide a stable, homogeneous optical environment having a refractive index, nₒ. In each PDMS step, the elastomer base and curing agent may be combined in a 10:1 mixing ratio and cured at room temperature for 48 hours in ambient conditions.

In some embodiments, index matching liquid for the fused silica substrate may be prepared by mixing glycerol (e.g., Sigma-Aldrich G9012) and distilled water. From an initial mixing ratio (90 vol % of glycerol and 10 vol % of water), more glycerol or water is added while observing the refraction angle at the interface between the liquid (nₘᵢₓ) and the fused silica (n_{FS}). Iterative minimization of the refraction with decreasing droplet volume leads to precise index matching ((nₘᵢₓ−N_{FS})/n_{FS}˜10⁻³) with the precision limited by the resolution of refraction angle. The waveguide 110, substrate 120, and the index matching liquid mixture may then be transferred together into an optical cube (e.g., a Thorlabs C6W) and mounted on a 6-degrees-of-freedom micromanipulation stage (e.g., having 3-axis translation and 3-axis rotation) for alignment with the beam path of the laser beam 130.

In some embodiments, during operation of the optical device 100, the laser beam 130 may be steered towards the edge of the waveguide 110 along an axis 122 relative to an axis 112 that is parallel to the plane of the waveguide 110. The axis 122 may be tilted by an angle, θ, relative to the axis 112. Preferably, the angle θ is approximately 0° such that the axis 122, and accordingly a beam center of the laser beam 130, is approximately parallel to the axis 112. In some embodiments, the angle θ may be greater than 0° but less than an angle of beam divergence of the laser beam 130. In some embodiments, the angle θ may be in a range from 0° to 5°.

In some embodiments, the laser beam 130 may be prepared using a super-continuum laser (e.g., a Fianium SC400) having a coherent wavefront over a broad range of wavelengths (e.g., from 450 nm to 1800 nm). The wavelength of interest for operation of the optical device 100 may be selected by using a double monochromator (e.g., a Princeton SP-2150i) to provide a bandwidth of approximately 2 nm. The prepared beam may then be fed into a single-mode fiber (SMF) configured to rectify the spatial mode distribution of the laser beam. The SMF may have a core diameter of approximately 5-μm.

As depicted in the example of FIG. 1C, the laser beam may then be coupled from the SMF to a series of relay optics based on an achromatic 4f configuration that is arranged to manipulate the beam to be collimated with a diameter in a range from 100 μm to 1 mm, in some embodiments. The alignment between the laser beam and the sample may be adjusted by observing the cross-sectional beam profile and transmitted beam power through the optical window of the cube at the opposite side by using a camera and a photodiode. Light outcoupled from the waveguide 110 and emitted through this same window may be collected by high numerical aperture optics (NA=0.65) for end-face imaging microscopy. In some embodiments, the beam polarization may be controlled by a linear polarizer followed by a half-wave plate.

Illustrative coupling efficiency measurements are shown in the example of FIG. 1C without the waveguide 110(i) and with the waveguide 110(ii), in accordance with some embodiments. Microscopy images taken in an end-face imaging configuration are shown in FIGS. 1D and 1E, where the end-face imaging configuration has a wider field-of-view configuration with NA=0.40 and the incident laser beam is tuned to match the divergence and vertical width of guided modes outcoupling from the waveguide (e.g., with an NA of approximately 0.1 and a beam width of approximately 6 μm). Both images were acquired using a wavelength of 720 nm. The scale bar in both images is equivalent to 50 μm, and the total counts measured in FIG. 1D, and the counts of guided light measured in FIG. 1E are 1.77×10⁷ and 2.70×10⁶, respectively.

The image of FIG. 1D was acquired without a waveguide present in the illustrative imaging system of FIG. 1C, and the image of FIG. 1E was acquired with a waveguide present, in accordance with some embodiments. The comparison reveals an intense out-coupled light field at the waveguide plane that is observed only when the waveguide is present. The intense light field is vertically confined, having a width of approximately 3 μm, and detected only with TE polarized excitation. From the two profiles, it can be determined that 15% of the total incident beam energy outcouples from the waveguide. It is estimated that the in-coupling efficiency is approximately 30% based on the measured propagation power loss of approximately 3 dB.

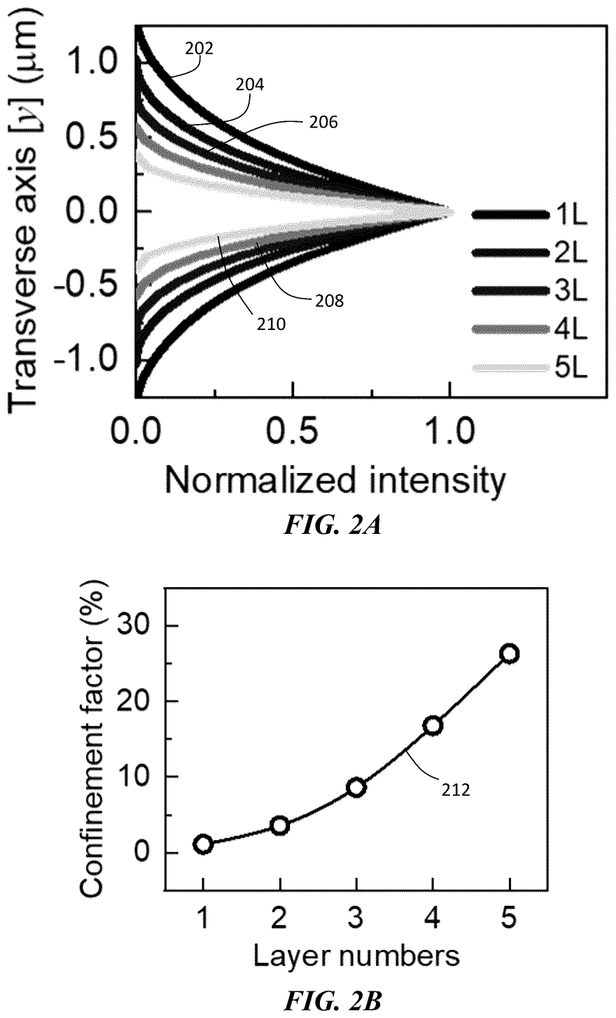

FIG. 2A is a plot showing simulated transverse line profiles of guided modes in multilayer MoS₂ thin film waveguides for waveguides having varying numbers of layers, in accordance with some embodiments. The transverse electric (TE) field profile along the confining z-direction is an optical analog of a quantum mechanical eigenfunction for a one-dimensional δ potential trap. Curve 202 shows a simulated transverse line profile for a monolayer MoS₂ thin film waveguide. Curve 204 shows a simulated transverse line profile for a MoS₂ thin film waveguide having two layers. Curve 206 shows a simulated transverse line profile for a MoS₂ thin film waveguide having three layers. Curve 208 shows a simulated transverse line profile for a MoS₂ thin film waveguide having four layers. Curve 210 shows a simulated transverse line profile for a MoS₂ thin film waveguide having five layers. As seen in FIG. 2A, the transverse line profile decreases in size with an increasing number of layers of the thin film materials.

FIG. 2B is a plot of curve 212 showing simulated confinement factors as a function of the number of layers in a thin film waveguide, varying from one layer to five layers, in accordance with some embodiments. This data shows that the confinement factor of guided waves in a monolayer MoS₂ waveguide is 1.09%, and thus more than 98% of light energy exists outside the waveguide. This factor exponentially changes with increasing layer numbers.

These simulations are consistent with theoretical descriptions of δ waveguides, whose ultra-small thickness t, satisfying nt/λ<<1, enables broadband, single-mode operation, where the out-of-plane confinement of a guided mode and its in-plane propagation can be independently controlled. This type of waveguide has a unique analytic solution when n>nₒ, where n is the refractive index of the waveguide material and nₒ is the refractive index of the surrounding medium. In particular, the imaginary wave vector along the z-direction |k_{z}| is much smaller than k_{∥}=(kₓ²+k_{y}²)^{1/2} regardless of n or λ. Because most of the optical fields are located outside of the waveguide owing to the thinness, this results in an effective mode index n_{eff}≈nₒ and a phase velocity v≈vₒ=c/nₒ (where c is the speed of light). The guided mode is therefore described by ω=v×k_{∥}, which is the dispersion relation of a plane wave confined in two-dimensional space.

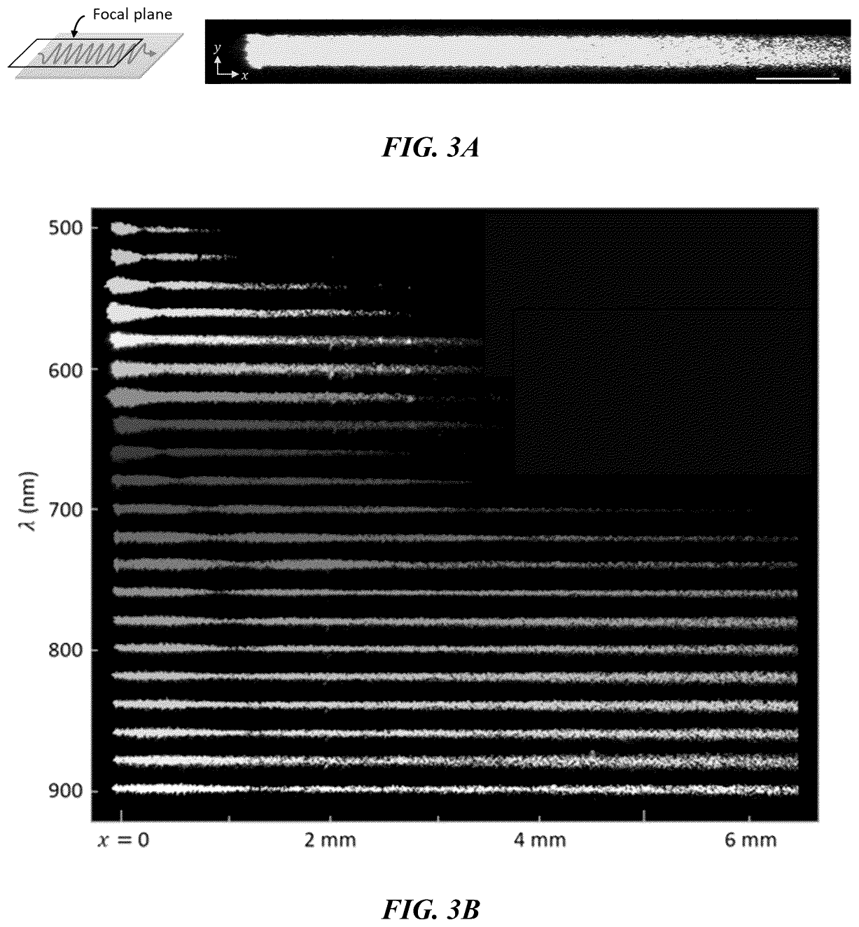

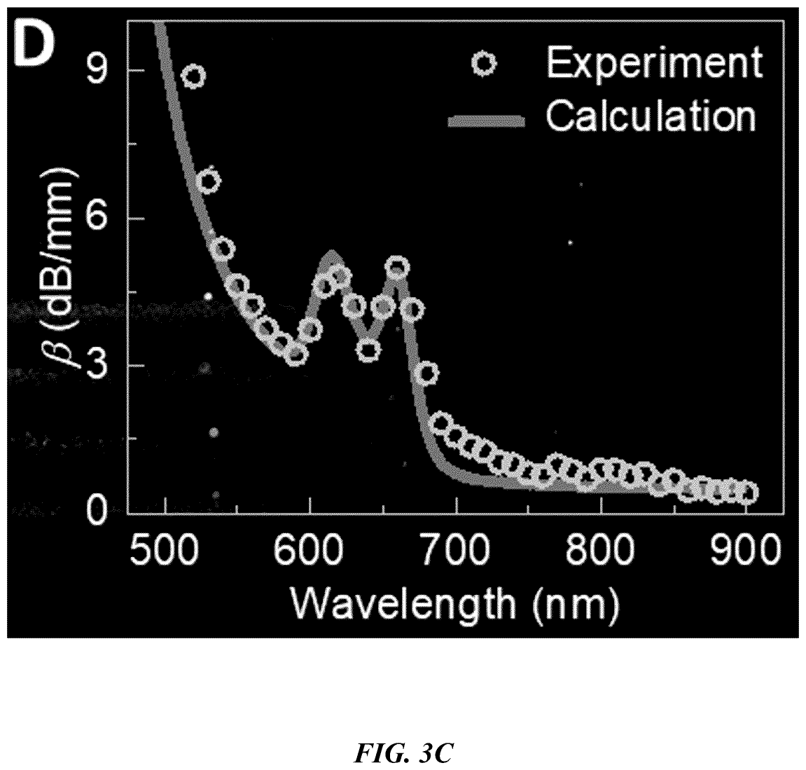

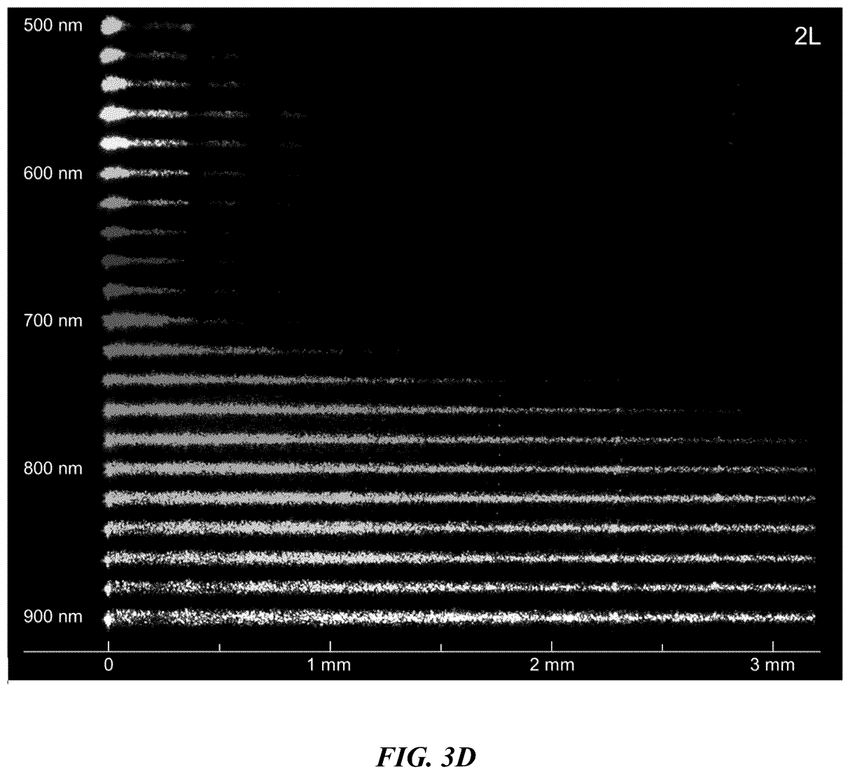

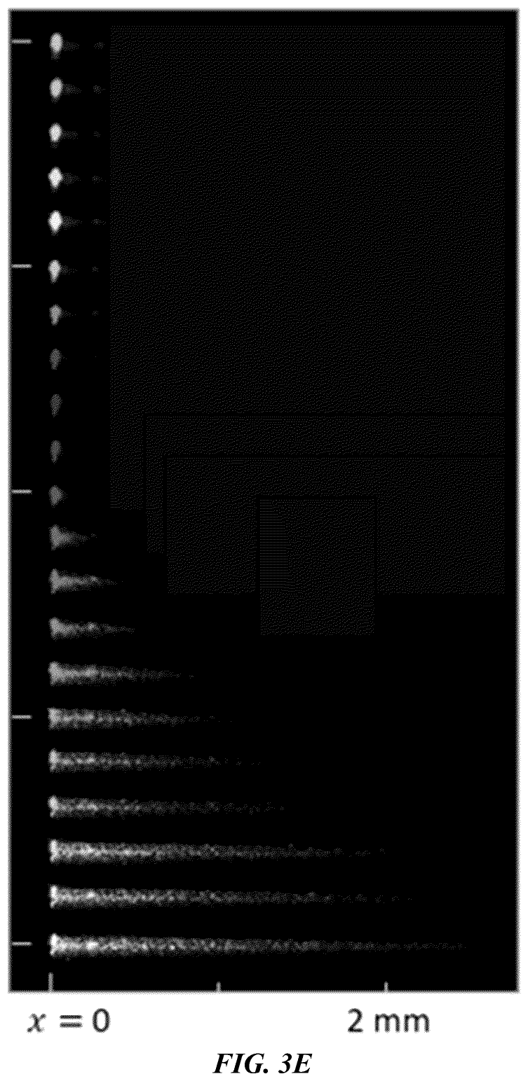

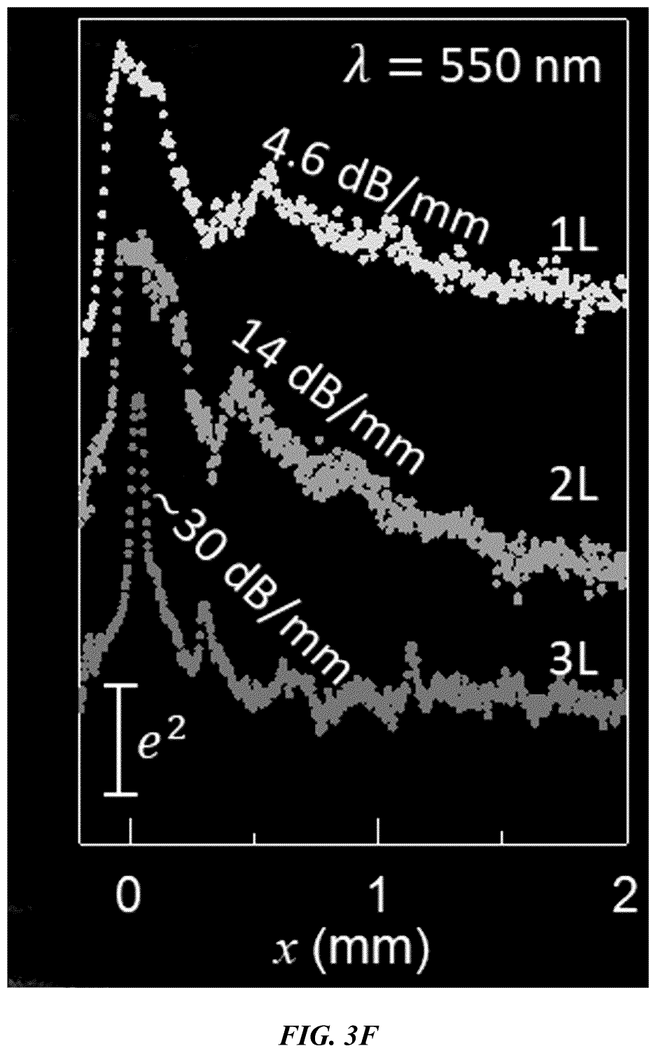

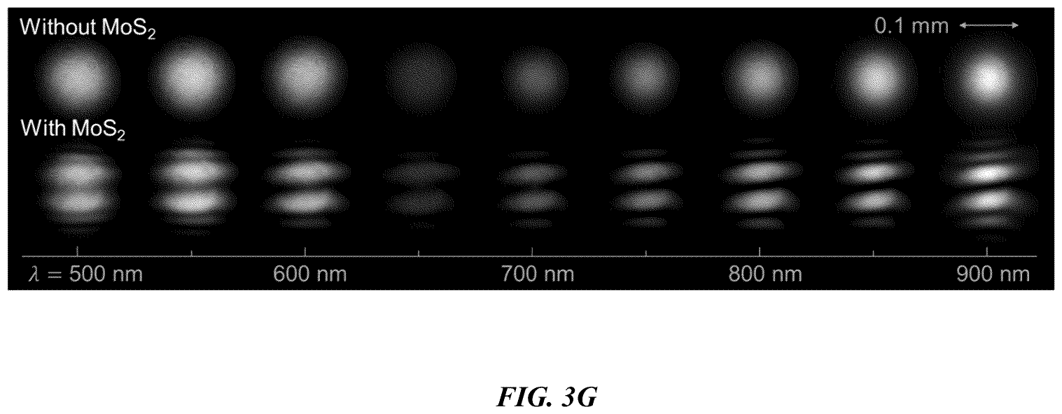

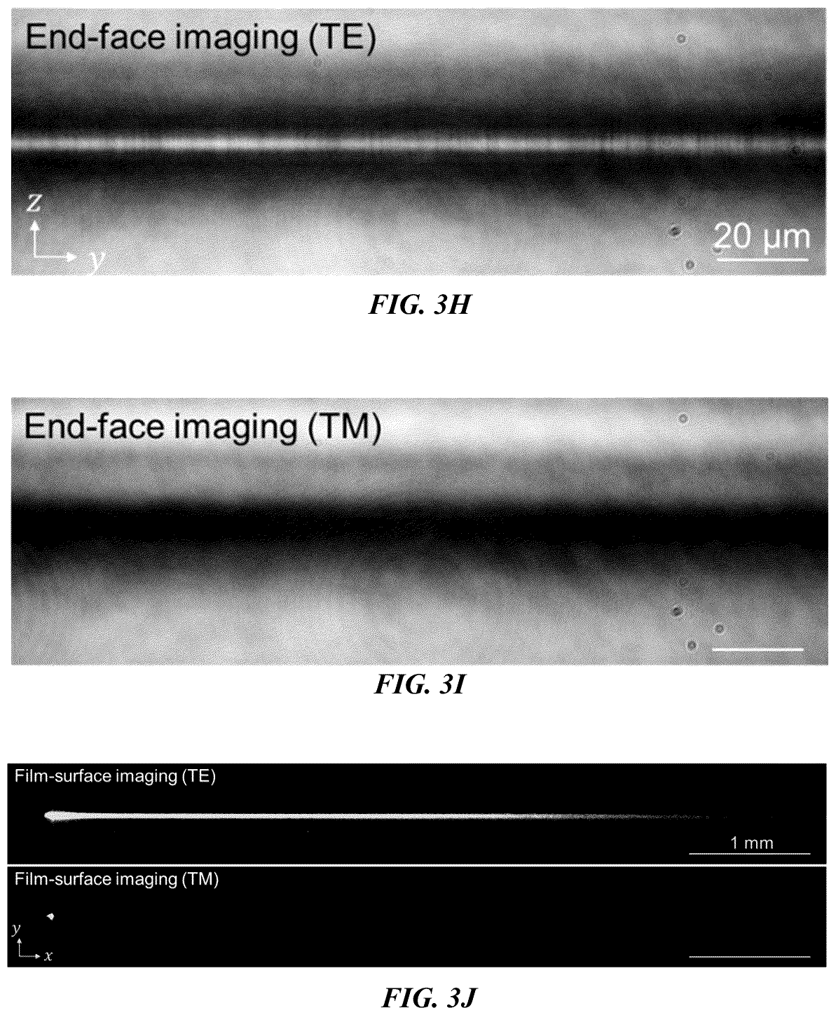

FIG. 3A shows a film-surface microscopy image of a guided electromagnetic wave in an MoS₂ thin film waveguide, in accordance with some embodiments. The image was acquired by collecting dark-field signals using an input wavelength of 720 nm and using TE polarization. The scale bar indicates a length of 0.2 mm. The image clearly shows strong signals from the MoS₂ surface along the laser beam path and having a lateral width similar to the beam diameter, which was approximately 100 μm.

In some embodiments, dark-field microscopy images are collected through a top port of the cube supporting the optical device and in a wide field-of-view configuration (e.g., with NA=0.05). An optical slit having a width of approximately 5 μm is disposed at the entrance face of the waveguide and a thermoelectrically cooled high quantum efficiency camera (e.g., a PCO Imaging Sensicam QE) was used for signal collections. The same configuration is used to measure multilayer samples, polymer-encapsulated samples, and patterned samples with reproducible results. All measurements are conducted under the ambient pressure and at room temperature.

FIG. 3B shows false-color dark-field microscopy images of a monolayer MoS₂ thin film waveguide having a length of 1 cm and for input laser beams having varying wavelengths in a range from 500 to 900 nm (Δλ=20 nm), in accordance with some embodiments. For longer wavelengths (e.g., greater than 700 nm), the propagating electromagnetic field remains intense over the length of the entire image, which was approximately 6 mm. For shorter wavelengths, the waveguide maintains the intensity of the guided electromagnetic wave for a shorter distance (e.g., equal or less than 2-3 mm).

FIG. 3C is a plot showing a rate of dark-field signal decay as a function of wavelength for the monolayer MoS₂ thin film waveguide of FIG. 3B, as determined by taking average slopes, I_{DF} (∝e^{-βx}), in log scale, in accordance with some embodiments. Experimental results are indicated by open circles. The continuous curve indicates the propagation loss of guided waves calculated independently using the experimental values of sheet susceptibility of MoS₂. The experimental values of dark-field signal decay closely match the calculated loss indicated by the continuous curve. For photon energies below E_{g}, where the MoS₂ absorption is small, the propagation loss is small, on the order of 0.5 dB/mm.

FIG. 3D shows false-color dark-field microscopy images of a bilayer MoS₂ thin film waveguide for varying wavelengths in a range from 500 to 900 nm (Δλ=20 nm), in accordance with some embodiments. Similarly, FIG. 3E shows dark-field microscopy images of a trilayer MoS₂ thin film for varying wavelengths of input light. For all wavelengths of input light, the signal decays fastest (e.g., in a shortest distance) in the trilayer waveguide imaged in FIG. 3E. Similarly, faster decays are observed for the bilayer MoS₂ waveguide than in the monolayer MoS₂ waveguide imaged in FIG. 3B, particularly for wavelengths below approximately 800 nm.

FIG. 3F shows intensity profiles of dark-field images as a function of propagation distance for MoS₂ thin films having one (1L), two (2L), and three (3L) layers, in accordance with some embodiments of the technology described herein. The dark-field images were acquired using an input wavelength of 550 nm. As seen in FIG. 3F, the decay rate appears to increase for waveguides with a larger number of layers.

The dark-field signals, such as those depicted in FIGS. 3B, 3D, and 3E, are detectable only when using a TE-mode laser and completely disappear when using a transverse magnetic (TM) polarization. FIG. 3G shows cross-sectional beam profiles without (top) and with (bottom) the presence of an MoS₂ thin film waveguide for wavelengths ranging from 500 to 900 nm, in accordance with some embodiments. FIGS. 3H and 3I show microscopy images taken in an end-facing configuration for TE and TM polarizations, respectively. FIG. 3J shows microscopy images taken in a top-down configuration for TE (top) and TM (bottom) polarizations, indicating that guided modes are limited in their propagation or not present when using TM polarized light.

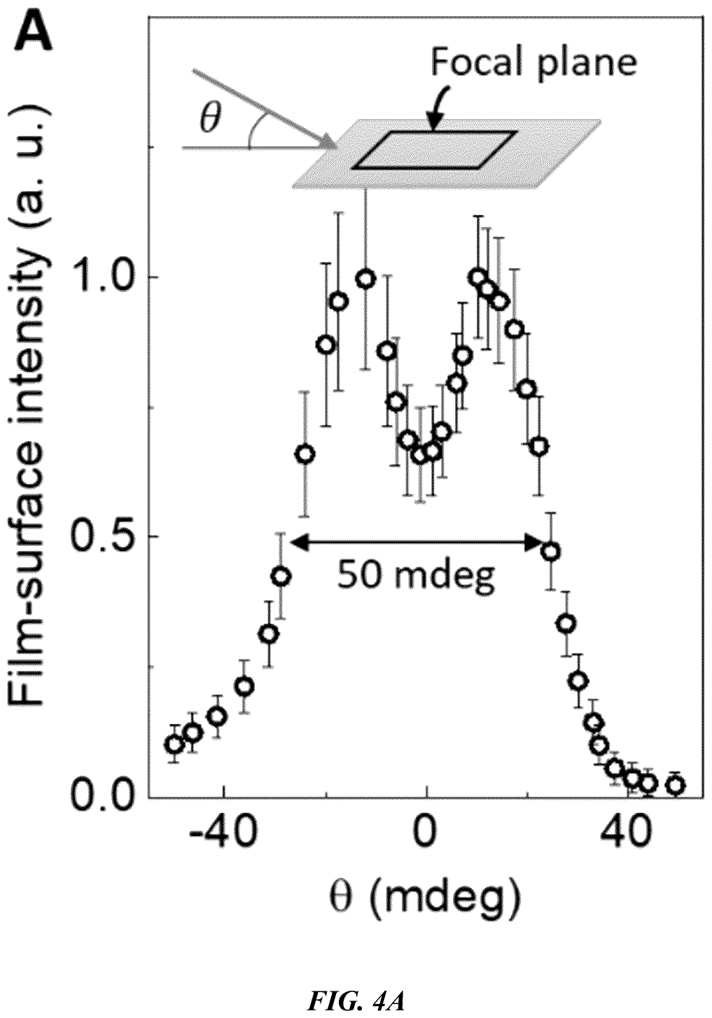

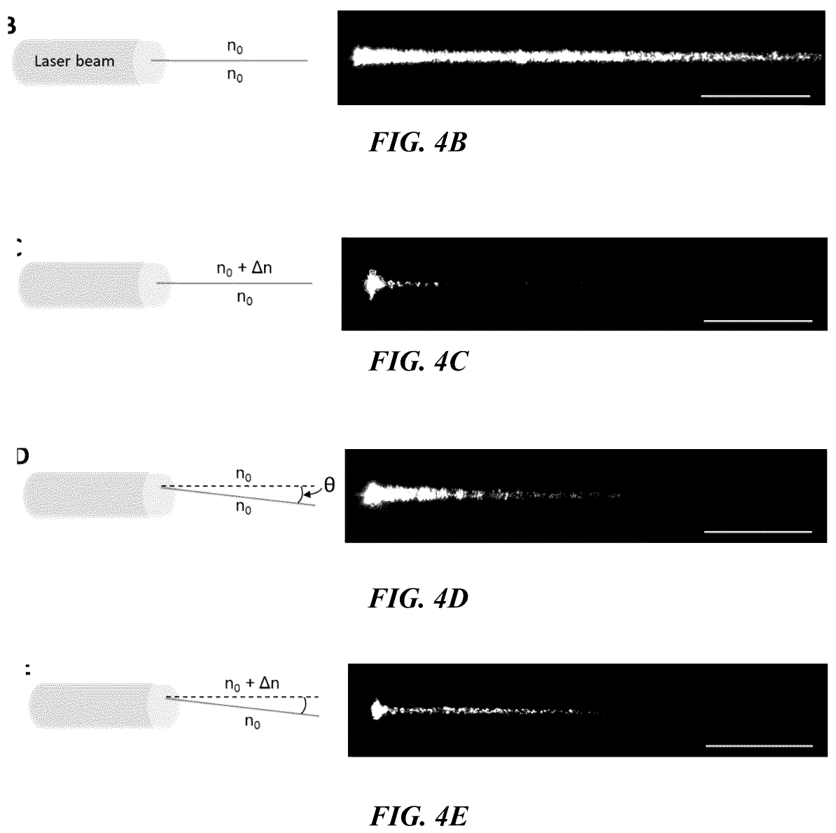

FIG. 4A is a plot showing measured intensity of a guided wave in a monolayer MoS₂ thin film measured as a function of incident angle, in accordance with some embodiments. The wavelength of light was 532 nm, and the magnitude of the incident angle was less than 50 mdeg. The intensity of the photoluminescence was measured instead of dark-field signals in order to improve the signal to noise ratio. The MoS₂ waveguide has a light mode whose momentum distribution (k_{∥}, k_{z}) corresponds to that of the light incoming at θ=±11 mdeg (≡±ε), with which it is that k_{z}/k_{∥}=tan (ε)≈10⁻⁴ and n_{eff}/nₒ=cos (ε)≈1.

Schematic diagrams and film surface images for different incoming angles of light are shown in FIGS. 4B-4E, where the scale bars indicate a length of 1 mm, in accordance with some embodiments. In FIG. 4B, the thin film waveguide was inside a material having a symmetric refractive index profile (Δn/n₀≈0) and had a near-zero tilting angle to the incident beam (θ≈0). The corresponding dark-field image shows substantial propagation of light through the waveguide. In FIG. 4C, the thin film waveguide was inside a material having an asymmetric refractive index profile (Δn/n₀≈0.9%) with θ≈0. In FIG. 4D, the thin film waveguide was inside a material having a symmetric refractive index profile (Δn/n₀≈0) with a non-zero tilting angle to the incident beam (θ=1.3°). In FIG. 4E, the thin film waveguide was inside a material having an asymmetric refractive index profile (Δn/n₀≈0.9%) with a non-zero tilting angle to the incident beam (θ=1.3°). Each of the dark-field images of FIGS. 4C-4E show reduced propagation relative to the dark-field image of FIG. 4B.

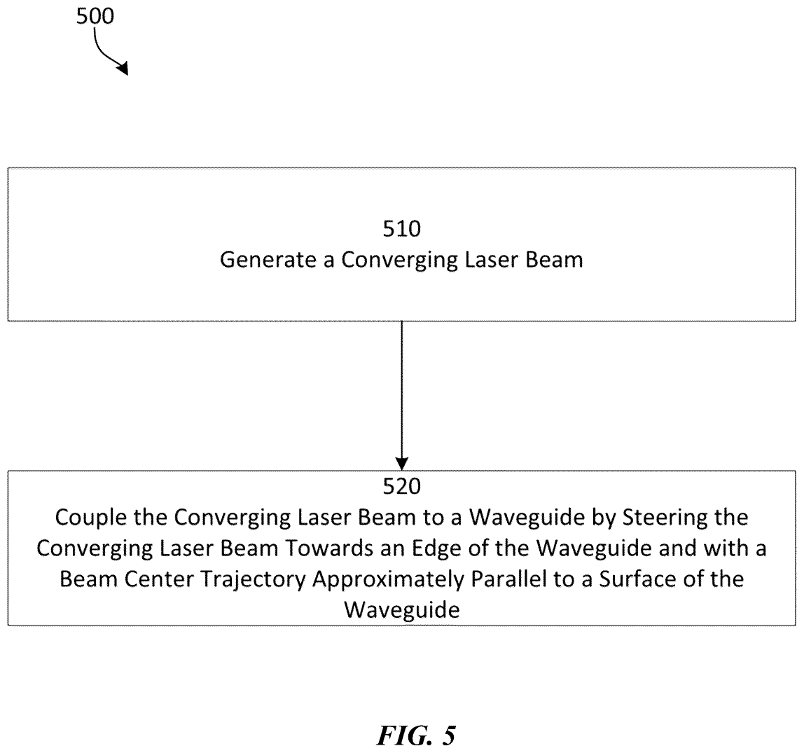

FIG. 5 is a flowchart describing a process 500 for operating an optical device (e.g., by generating a guided electromagnetic wave), in accordance with some embodiments of the technology described herein. The process 500 may begin at act 510, in which a converging laser beam may be generated. As one non-limiting example, the converging laser beam may be generated by providing a coherent laser beam (e.g., having a wavelength in a range from 500 nm to 900 nm or in a range from 450 nm to 1800 nm) to a single-mode optical fiber for output to a series of relay optics configured to manipulate and collimate the laser beam. For example, the relay optics may be arranged based on an achromatic 4f configuration (e.g., as described in connection with FIG. 1C herein).

In some embodiments, the resulting converging laser beam may be generated with a numerical aperture (NA) in a range from 0.01 to 0.6, in a range of 0.05 to 0.3, or in any suitable range within those ranges. Additionally, in some embodiments, the converging laser beam may be generated with a focused beam width (i.e., at the focal point of the laser beam) in a range from 1.3 μm to 550 μm, in a range from 1.3 μm to 100 μm, in a range from 2 μm to 10 μm, or in any suitable range within those ranges.

After act 510, the process 500 may proceed to act 520, in which the converging laser beam may be coupled to the waveguide to generate a guided electromagnetic mode within the waveguide. The converging laser beam may be coupled to the waveguide by steering the converging laser beam towards an edge of the waveguide. In some embodiments, the waveguide may be a thin film waveguide (e.g., having an approximately two-dimensional, planar geometry). For example, steering the converging laser beam towards an edge of the thin film waveguide may include steering the converging laser beam towards an edge of a thin film material as described herein, including but not limited to a vdW material and/or a TMD.

In some embodiments, the converging laser beam may also be steered such that it has a beam center trajectory approximately parallel to a surface of the waveguide. In some embodiments, the tilting angle between the converging laser beam and the surface of the waveguide is less than the angle of the beam divergence of the converging laser beam.

### II. Manipulating Guided Modes in Thin Film Waveguides

Guided modes in a two-dimensional, δ waveguide are effectively evanescent waves whose optical fields are found mostly outside the waveguide. The inventors have recognized and appreciated that engineering optical properties of the environment around a waveguide directly tunes the mode refractive index (n_{eff}≈nₒ) and would change the propagation properties of the guided modes within the waveguide. Accordingly, the inventors have developed techniques for manipulating guided modes in waveguides, including the integration of thin-film elements and direct microfabrication and optical excitation of the waveguide material.

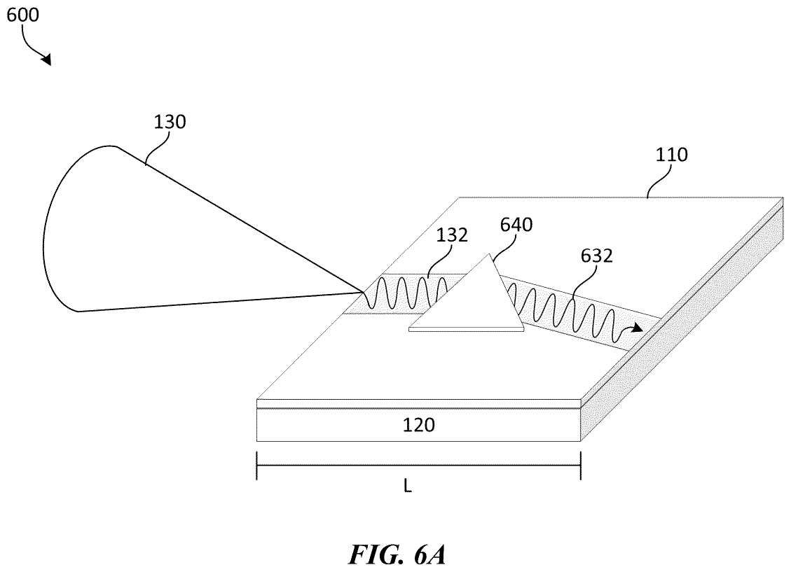

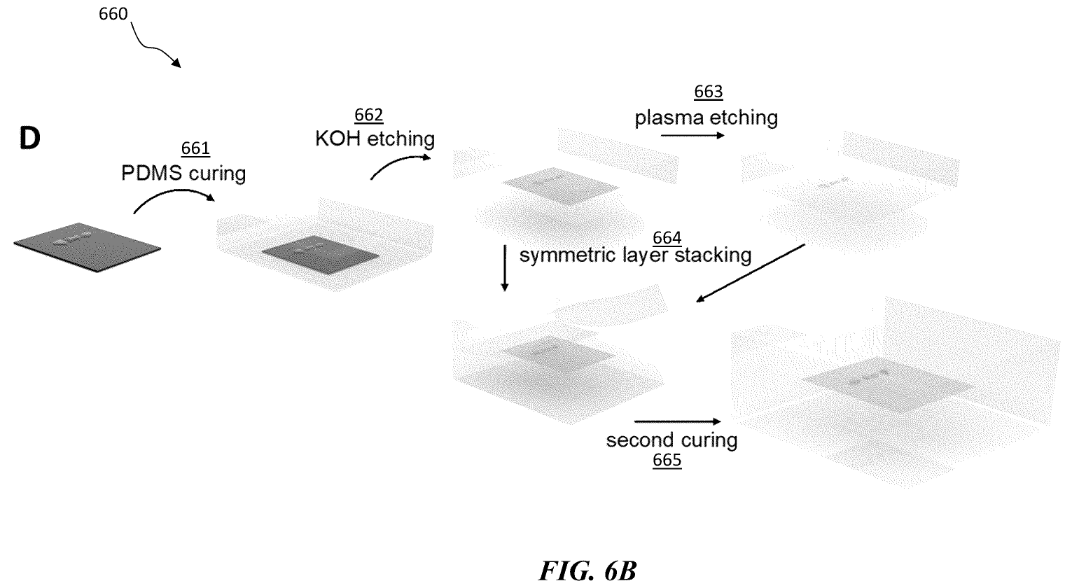

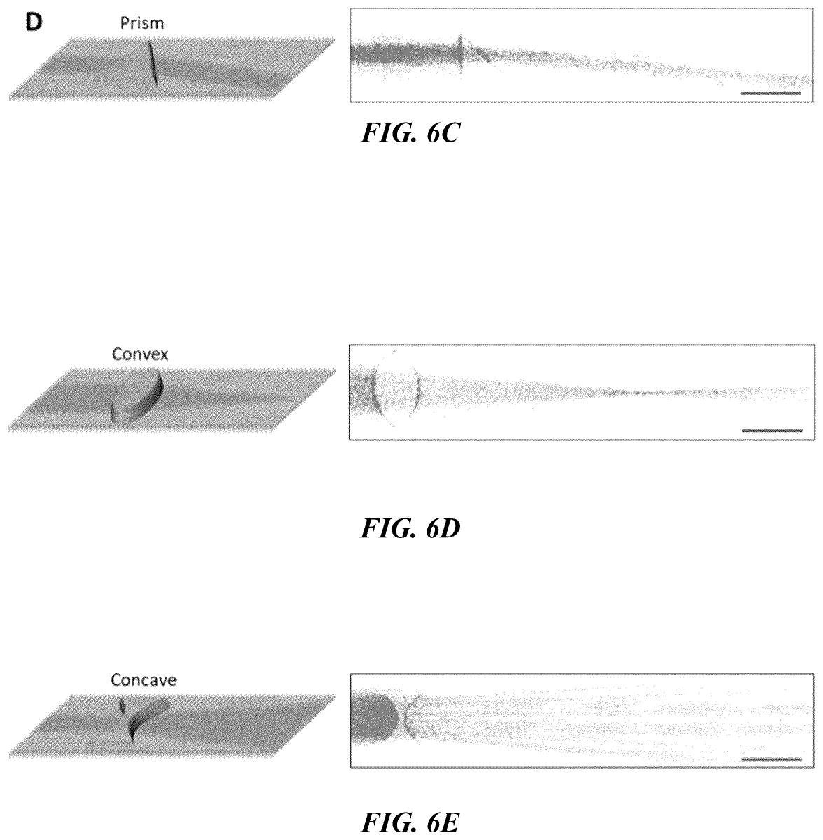

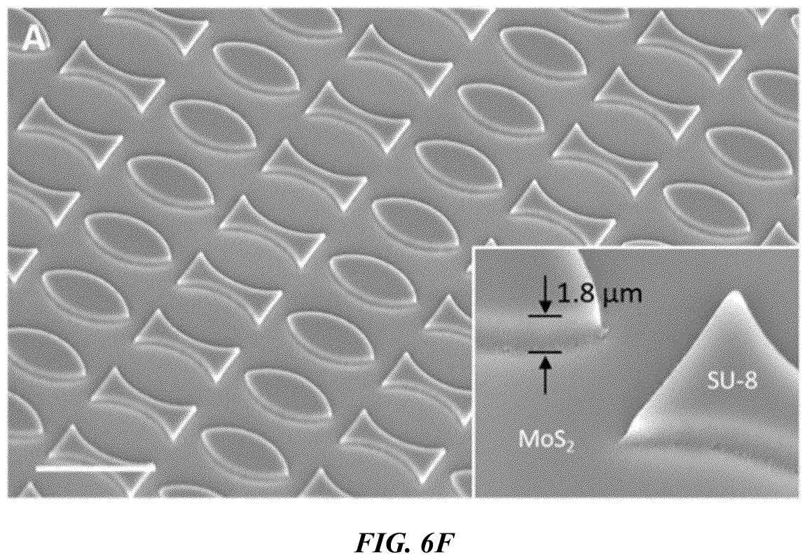

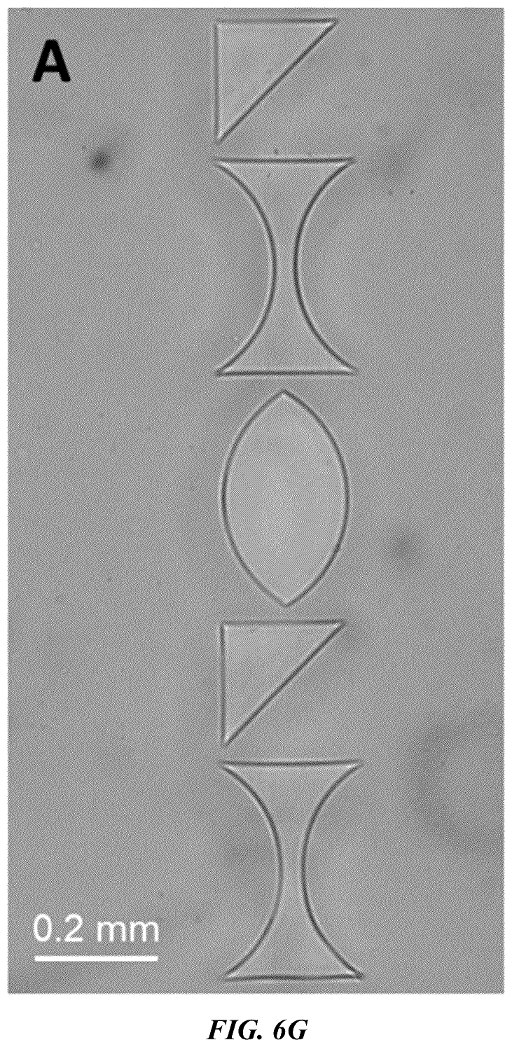

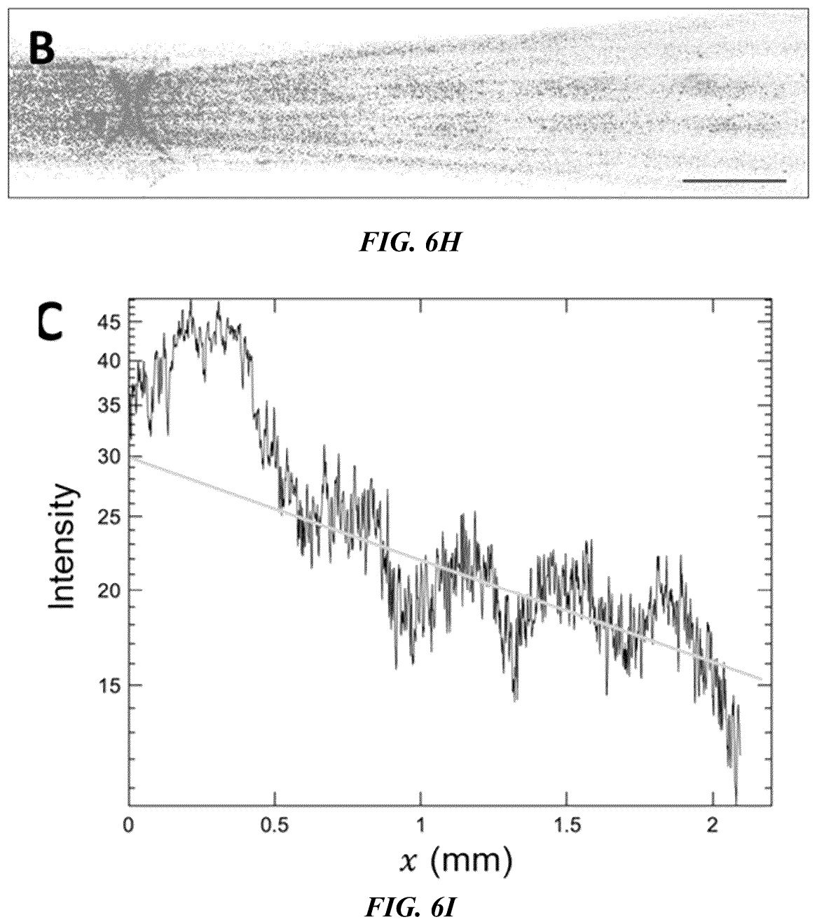

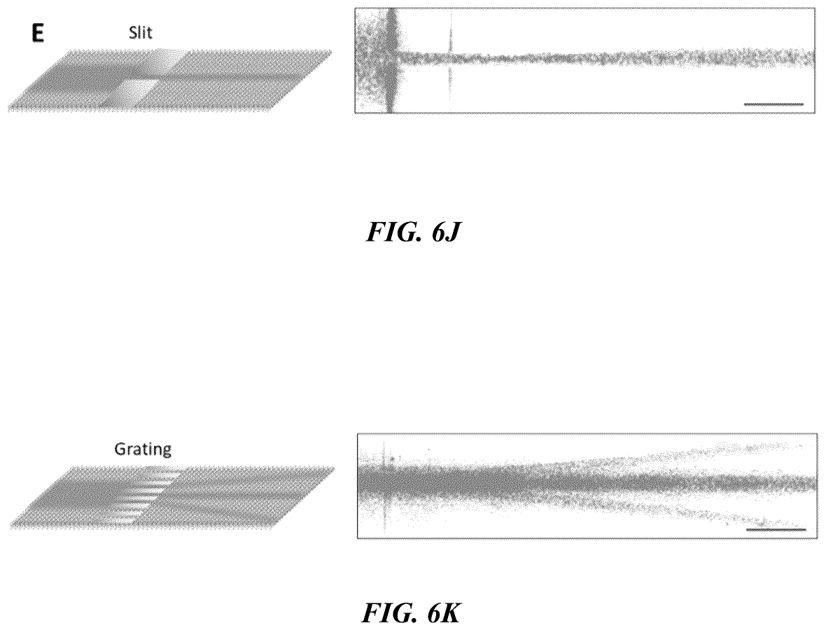

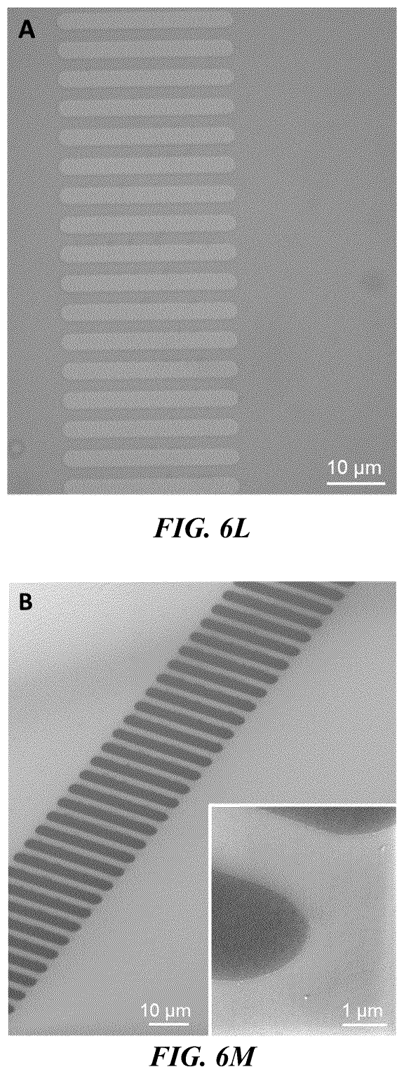

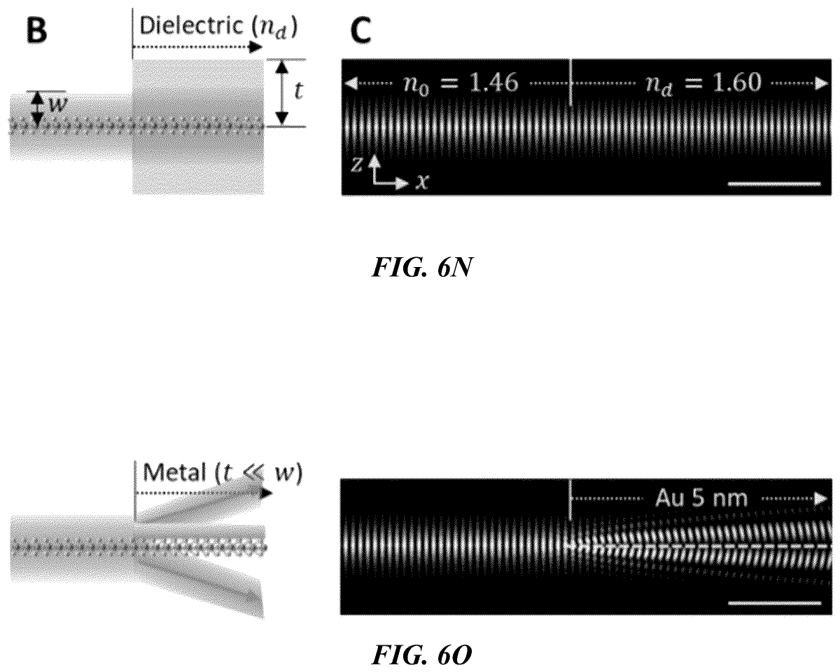

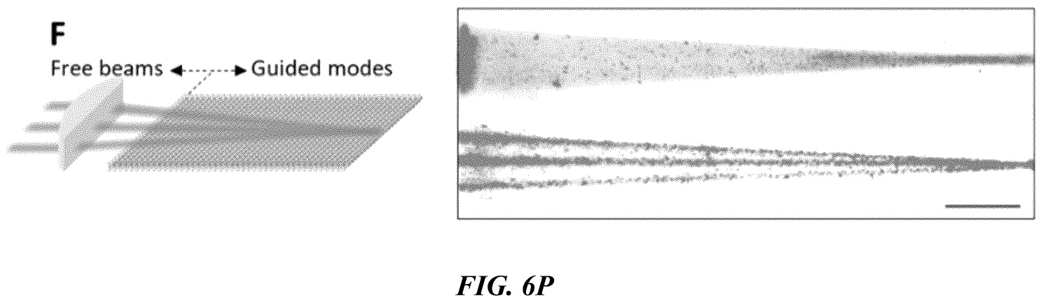

FIG. 6A is a schematic diagram of an example of an optical device 600 for generating a guided electromagnetic wave in a waveguide and including an optical element, in accordance with some embodiments of the technology described herein. The optical device 600 includes the waveguide 110 and substrate 120 as described in connection with the example of FIG. 1A and further includes an optical element 640 disposed on a surface of the waveguide 110. The optical element 640 may be a thin film element disposed adjacent (e.g., on, in, or next to) the waveguide 110.

In some embodiments, the optical element is disposed above or below a plane of the waveguide, such that the optical element is out-of-plane relative to the plane of the waveguide. In some embodiments, the optical element may be disposed above or below a plane of the waveguide and spaced apart from the planar surface of the waveguide by a distance configured to permit the optical element to interact with propagating guided modes in the waveguide.

In the example of FIG. 6A, the optical element 640 is triangular in shape, is disposed on a surface of the waveguide 110, and is configured to act like a prism, bending guided electromagnetic wave 132 to generate manipulated electromagnetic wave 632 with a different trajectory than guided electromagnetic wave 132, in accordance with some embodiments. However, it should be appreciated that the optical element 640 is not limited to being a prism as shown in the example of FIG. 6A. Rather the optical element 640 may be any optical element disposed adjacent to the waveguide 110 and configured to manipulate the guided electromagnetic wave 132, as aspects of this disclosure are not limited in this respect. Additional non-limiting examples of optical elements that may be used in optical device 600 are described herein in connection with FIGS. 6C-6G.

In some embodiments, the optical element 640 may be a thin film dielectric material. As one non-limiting example, the optical element 640 may be a photoresist material (e.g., SU-8 or another suitable photoresist). The dielectric film may have a thickness on the order of microns (e.g., in a range from 1 μm to 5 μm). FIG. 6B is a diagram illustrating a process 660 for manufacturing optical elements using a photoresist material. The optical element may be fabricated using a lithography process (e.g., using a Heidelberg MLA150) on the waveguide material while it is supported by the growth substrate (e.g., fused silica).

In some embodiments, after fabricating the optical elements using lithography, the process may proceed to act 661. At act 661, a liquid elastomer mixture (e.g., PDMS) was poured to cover the waveguide and the patterned optical elements, and after degassing and curing, a solid elastomer block was formed. Thereafter, the process may proceed to act 662, in which the elastomer block is immersed in a KOH (˜1 M) solution to etch away the growth substrate.

In some embodiments, a mirror-reflection version of the optical elements was made and then, at act 663, subjected to fluorine plasma etching (e.g., using a Plasma-Therm ICP Fluoride Etch) and oxygen plasma etching (e.g., using a Yield Engineering Systems VLF-1000) to remove the waveguide material layer and to enhance the adhesion of the elastomer material, respectively. At act 664, these two elastomer layers were combined with an alignment system used for dry transfer of two-dimensional materials. Placing optical elements only on top of a waveguide induces asymmetry weakening the confinement and increasing optical loss. Using symmetric refractive elements by transferring identical components on either side of the waveguide improves the transmission by up to 85%. At act 665, this stacked elastomer block was encapsulated by additional liquid elastomer and cured a second time to make the elastomer surface optically smooth and improves the mechanical strength of the device.

FIGS. 6C-6E display schematic diagrams and experimental images illustrating how guided waves interact with different dielectric optical elements disposed on only one side of the waveguide material, in accordance with some embodiments. The scale bar indicates a length of 1 mm, and the experimental images were obtained using a wavelength of 720 nm. The measured beam trajectory shown in FIG. 6C demonstrates that a prism component changes the propagation direction. The measured beam trajectory shown in FIG. 6D demonstrates that a convex lens shapes the wavefront of incident waves from planar to a convergent form. The measured beam trajectory shown in FIG. 6E demonstrates that a concave lens shapes the wavefront of incident waves from planar to a divergent form.

Scanning electron microscope (SEM) of single-sided optical elements and optical images of stacked prism, convex lens, and concave lens optical elements are shown in FIGS. 6F and 6G, respectively, in accordance with some embodiments. FIG. 6H is a dark-field microscopy image of guided waves interacting with stacked optical elements (e.g., having substantially identical optical elements disposed on opposing sides of the waveguide) that are convex lenses, where the scale bar indicates a length of 0.5 mm. FIG. 6I is a plot of the intensity profile of the dark-field image of FIG. 6H as a function of propagation distance, in accordance with some embodiments of the technology described herein. As shown by FIG. 6I, and compared with FIG. 6E, energy loss in the waveguide of FIG. 6H is significantly reduced compared to single layer optical components and is calculated to be approximately 15% due to the convex lens.

In some embodiments, the optical element 640 may be formed of a thin metallic film. In some embodiments, the thin metallic film may be fabricated using photolithography techniques. For example, a photoresist (e.g., an AZ1512/PMMA double layer) may be spin coated onto the waveguide material supported by the growth substrate. The photoresist may then be patterned using photolithography. Thereafter, a thin metallic film may be deposited (e.g., using evaporator, sputtering, or other suitable techniques), and the photoresist may be removed by chemical lift-off (e.g., using a suitable solvent such as acetone). For example, a gold film (e.g., having a thickness of approximately 5 nm) may be deposited on the patterned photoresist to deposit patterned gold structures on the waveguide material. In some embodiments, the metallic film may have a thickness on the order of nanometers (e.g., in a range from 2 nm to 10 nm) or on the order of microns (e.g., in a range from 1 μm to 5 μm).

FIGS. 6J and 6K display schematic diagrams and experimental images illustrating how guided waves interact with metallic optical elements disposed on only one side of the waveguide material, in accordance with some embodiments. The scale bar indicates a length of 1 mm, and the experimental images were obtained using a wavelength of 720 nm. The measured beam trajectory shown in FIG. 6J demonstrates that a slit component reduces the incident beam width to leave a narrow line matching the width of the slit. The slit geometry may be made by two metal sheets with a gap space (e.g., having a width of approximately 3 μm). The measured beam trajectory shown in FIG. 6K demonstrates that a grating component also causes diffraction of the propagating electromagnetic wave. The particular grating of the example of FIG. 6K is an arrangement of multiple slits having a same slit space with a periodicity of 5 μm, which generates first-order diffracted beams deflecting at 5.6°. An optical microscope and SEM image of an example of a metallic grating are shown in FIGS. 6L and 6M, respectively.

FIGS. 6N and 6O are illustrations and simulations of index modulation of guided modes caused by a dielectric thin film and a metallic film, respectively, in accordance with some embodiments of the technology described herein. The scale bars indicate a length of 2 μm. As shown in FIG. 6N, transparent dielectric films with a thickness t>w, where w is the mode width, can alter the effective refractive index in the waveguide and therefore control the wavefront of the guided mode. In contrast, as shown in FIG. 6O, metallic films have a large extinction coefficient and can carry only TM modes, which do not allow TE modes to propagate. Thus, metallic films block TE-guided modes in the thin film waveguide. The simulations confirm that the effective mode index (n_{eff}) changes from n₀ to n_{d} across the dielectric interface with negligible back scattering as a result of the similar mode widths (Δw/w=0.02; FIG. 6N). The simulation also shows in FIG. 6O that a 5-nm thick gold film on a monolayer MoS₂ thin film fully scatters the incoming waves and completely blocks the propagation of guided waves.

The simulations of FIGS. 6N and 6O were performed using a commercial package (e.g., Lumerical FDTD Solution). The monolayer MoS₂ was modeled as a slab with a 0.65-nm thickness (t) lying in the z=0 plane. Bilayer and trilayer MoS₂ thin films were modeled as 2t and 3t thick slabs, respectively. The complex dielectric constant of MoS₂ (ε) is taken from experimental measurements on sheet susceptibility (χ) of monolayer MoS₂. The dielectric constant of the surrounding environment is set to the real value of the fused silica substrate (n_{FS}=1.46 at a wavelength of 532 nm), neglecting the imaginary component. A plane wave or line dipole is then arranged as a light source to simulate the beam-waveguide interaction and guided wave propagation, respectively. In both cases, the electromagnetic field of light source is set as a continuous wave at 532-nm vacuum wavelength having transverse electric polarization (i.e., electric field oscillating in x-y plane).

The model system is numerically simulated in a calculation domain set as a two-dimensional box having length dimension (100 μm, 100 μm) in the x-z plane by taking advantage of the translational symmetry on the y-axis. The boundary condition of the two-dimensional box is arranged for perfectly matching layers and periodic for x- and z-axis, respectively. The spatial resolution of the two-dimensional box is determined by using the graded mesh algorithm (grading factor: √2) with two constraints: (1) a minimum of 10 calculation cells for each unit wavelength interval and (2) a 0.065-nm z-resolution in a region of |z|≤6.5 nm containing the MoS₂ thin film centered at z=0. The temporal resolution of the time-domain solver is then chosen for Δt=0.0021 fs over a time train of 1000 fs, which provides stable convergence under the specified spatial discretization.

In some embodiments, the optical element 640 may be disposed adjacent an edge of the waveguide 110 such that the optical element 640 is disposed between the incoming laser beam 130 and the waveguide 110. FIG. 6P shows a schematic diagram of an optical element delivering a designed wavefront to the thin film waveguide and a corresponding dark-field microscopy image of the interaction of the wavefront with the thin film waveguide, in accordance with some embodiments of the technology described herein. The scale bar indicates a length of 1 mm, and the experimental images were obtained using a wavelength of 720 nm. In FIG. 6P, a cylindrical convex lens is placed before the waveguide to focus one (upper dark-field image) or more (lower dark-field image) incoming laser beams in the x-y plane. The dark-field images show that the waveguide takes different incoming waves and focuses them sharply within the waveguide, regardless of the beam diameter or the number of incident beams. This demonstrates that thin film waveguides allow impedance matching with free-space optics, and thus the two-dimensional waveform remains during the transformation between free beams and guided modes.

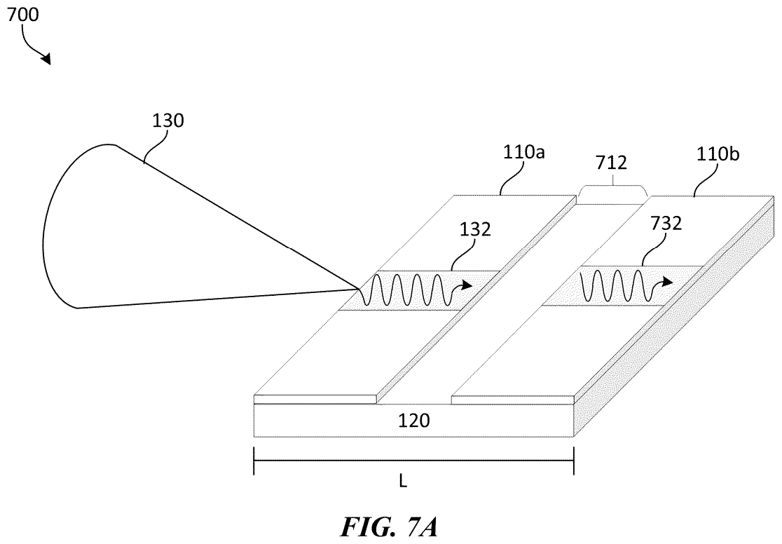

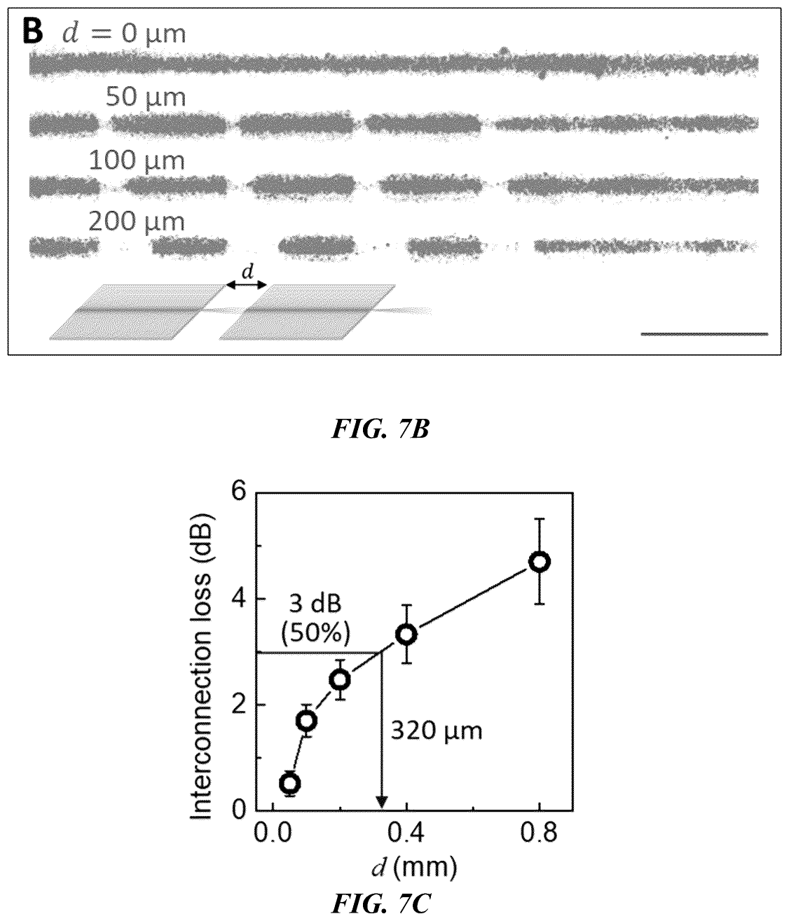

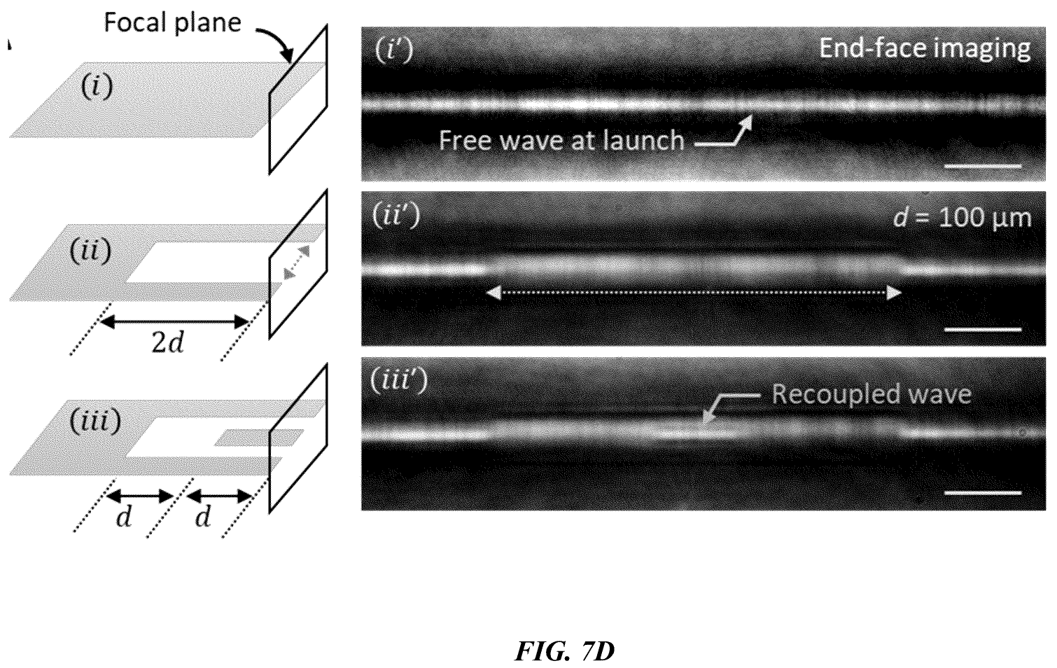

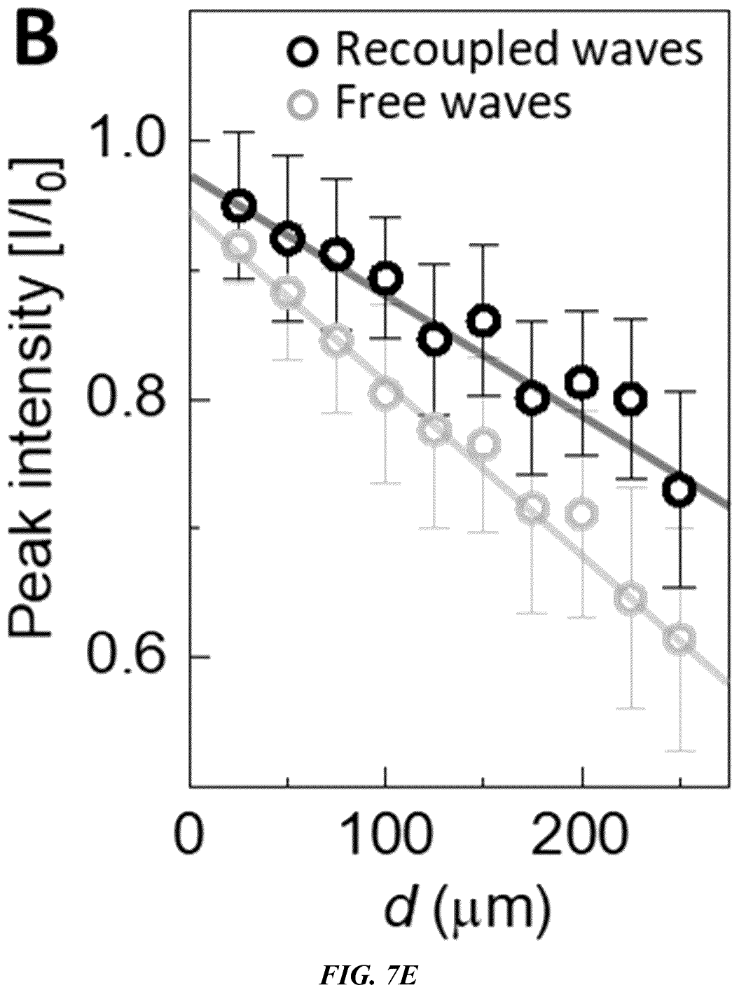

In some embodiments, the optical element may be in a plane of the waveguide (e.g., a patterned portion of the waveguide material). FIG. 7A is a schematic diagram of an optical device 700 for generating a guided electromagnetic wave transported across interconnected waveguides separated by a distance, in accordance with some embodiments of the technology described herein. The waveguides include a first portion 110a separated from a second portion 110b by a gap 712. The gap 712, and any patterned waveguides described herein, may be fabricated using a laser scriber (e.g., a Keyence T-centric laser marker MD-T1010W). During laser scribing, the waveguide material may be exposed to 532-nm Q-switched laser (e.g., a MD-T1000 laser) at 30-MW/cm² average power density and 300-kHz Q-switching frequency. Patterns are then generated by raster scanning of the laser beam.

In some embodiments, during operation of the optical device 700, the laser beam 130 may be optically coupled with an edge of the first portion 110a of the waveguide to generate the guided electromagnetic wave 132. The guided electromagnetic wave 132 may then propagate through the first portion 110a of the waveguide until it reaches gap 712. The guided electromagnetic wave may then couple to the second portion 110b of the waveguide, generating a second guided electromagnetic wave 732.

FIG. 7B shows how a guided wave propagates across the interconnection geometry where a thin film waveguide is disconnected into several segments separated by regions void of waveguide material with a varying gap distance d, in accordance with some embodiments. The experimental images were acquired with an input wavelength of 750 nm, and the scale bar indicates a length of 0.5 mm. The dark-field intensity suggests a high interconnection efficiency. FIG. 7C is a plot of interconnection loss as a function of interconnection distance as shown in FIG. 7B and indicates an approximate 0.1-dB loss per 10-μm gap distance, d. The interconnection loss is as low as approximately 0.5 dB at a 50-μm distance, and the loss monotonically increases to approximately 3 dB for a 320-μm distance for 3 dB loss, as indicated by the arrow.

These loss observations are consistent with those measured in various end-face microscopy arrangements, as shown in FIG. 7D, in accordance with some embodiments. FIG. 7D shows end-face images for waveguides having three different geometries: (i) a solid waveguide, (ii) a waveguide followed by a free space, and (iii) two waveguides separated by a distance, d. As shown in the top microscopy image, at the end of a single waveguide, a line of tightly confined signal is visible, corresponding to a guided wave at the input. The middle image is taken with a focal plane 200-μm away from the edge of the waveguide. The signal at the center in the middle images appears only slightly broader compared to the one in top image, suggesting that the out-coupled free wave remains narrowly confined in the transverse profile, having an apparent width of approximately 6 μm. The bottom image shows what occurs if another waveguide segment is introduced to recouple a free wave after d=100 μm. The bottom image displays a tightly confined line in the center of the image with a similar width as in the top image, suggesting an efficient recoupling to a guided wave.

FIG. 7E is a plot showing peak intensity changes for different values of distance for free waves and recoupled waves, in accordance with some embodiments of the technology described herein. The data shown in black is for recoupled waves, and the data shown in gray is for free waves. This shows that a free wave output by a thin film waveguide can recouple to a next waveguide efficiently, maintaining a peak intensity greater than 70% up to d=250 μm.

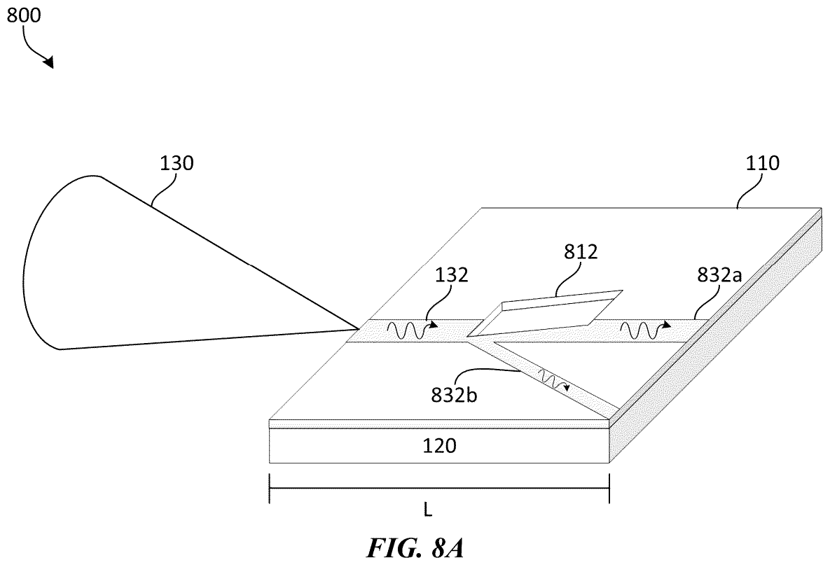

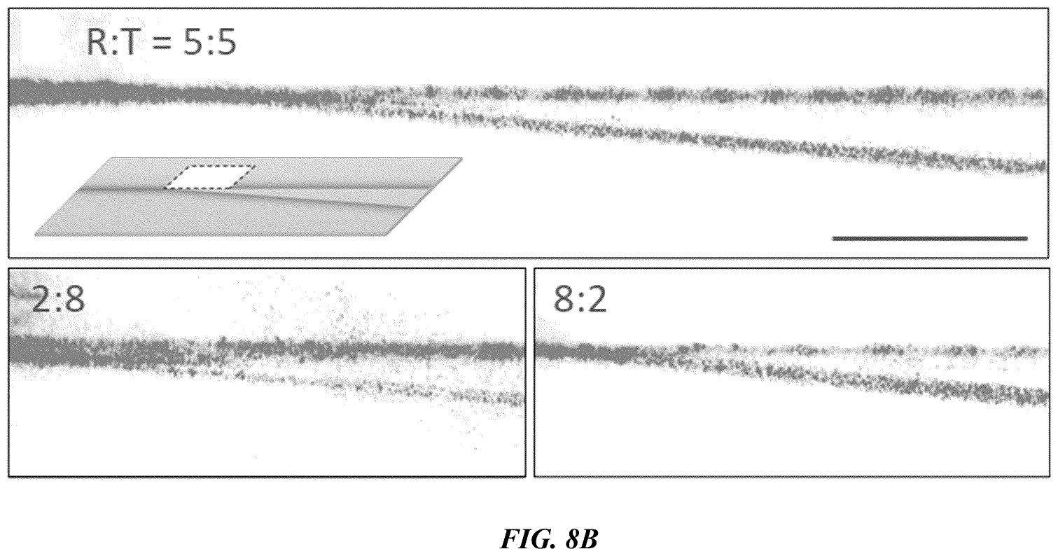

In some embodiments, a portion of the waveguide material may be removed to cause splitting of the guided electromagnetic wave. FIG. 8A is a schematic diagram of an example of an optical device 800 for splitting a guided electromagnetic wave, in accordance with some embodiments of the technology described herein. The waveguide 110 has been patterned to include a void 812 arranged to split the incoming guided electromagnetic wave 132 into two portions. In some embodiments, the void 812 may be fabricated using laser scribing, as described herein.

In some embodiments, during operation of the optical device 800, the laser beam 130 may be optically coupled with an edge of the waveguide 110 to generate the guided electromagnetic wave 132. The guided electromagnetic wave 132 may then encounter the void 812 and split into two portions. The first portion 832a may continue along a same direction of propagation as the guided electromagnetic wave 132, and the second portion 832b may diverge at an angle relative to the direction of propagation of the guided electromagnetic wave 132.

In some embodiments, the void 812 may be generally square or rectangular in shape, and a corner of the void 812 may be disposed in a region of the waveguide 110 through which the guided electromagnetic wave 132 propagates during operation of the optical device 800. The deflection angle, which may be up to 10°, and splitting ratio can be controlled by the position and angle of the void 812 relative to the guided electromagnetic wave 132.

FIG. 8B shows dark-field microscopy images of split and deflected guided electromagnetic waves, in accordance with some embodiments of the technology described herein. The experimental images were acquired using light having a wavelength of 750 nm, and the scale bar indicates a length of 1 mm. FIG. 8B includes three insets showing different splitting ratios of 8:2, 5:5, and 2:8.

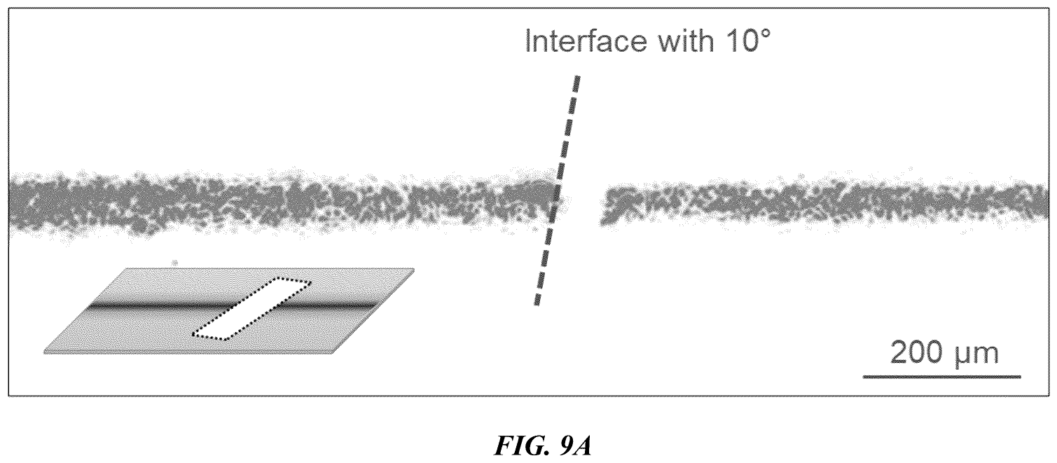

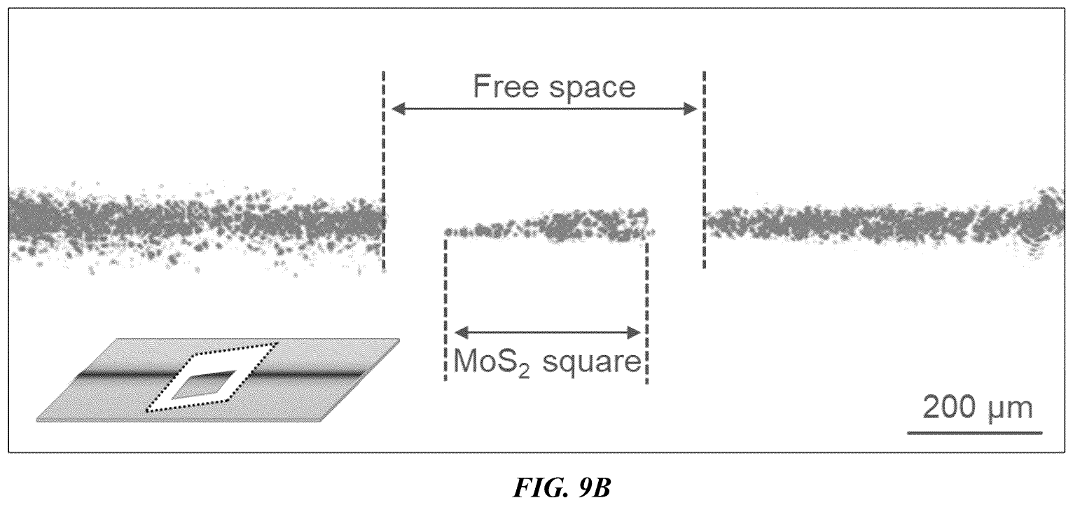

This splitting behavior as shown in FIG. 8B is not seen in other configurations or when a corner is introduced to a decoupled beam, as depicted in FIGS. 9A and 9B, in accordance with some embodiments. FIG. 9A is a dark-field microscopy image of the propagation of a guided electromagnetic wave across a region without dielectric thin film that is tilted relative to a direction perpendicular to the direction of transmission of the guided electromagnetic wave. FIG. 9B is a dark-field microscopy image of the propagation of a guided electromagnetic wave across a region that is tilted relative to a direction perpendicular to the direction of transmission of the guided electromagnetic wave, the region having areas without the thin film waveguide material and areas having the thin film waveguide material. The corner of the respective voids in FIGS. 9A and 9B do not interact with the incoming guided mode, and either splitting nor diverting is observed.

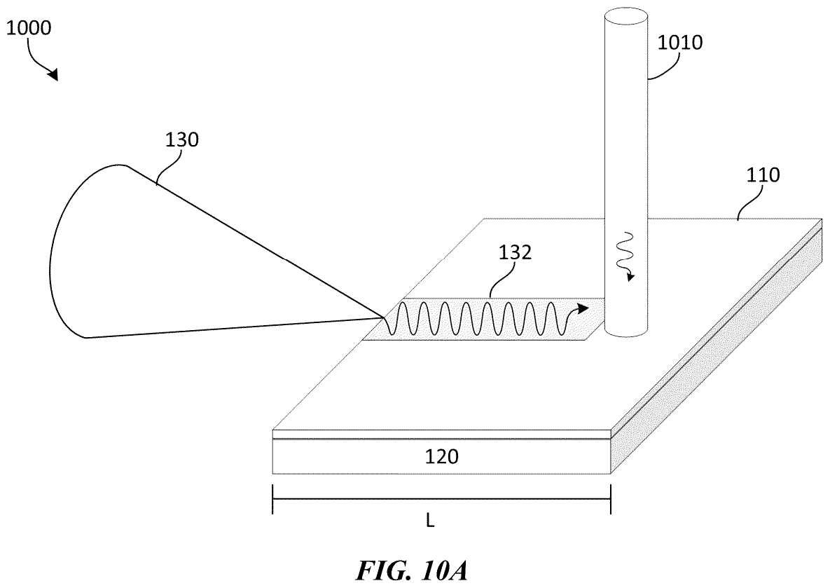

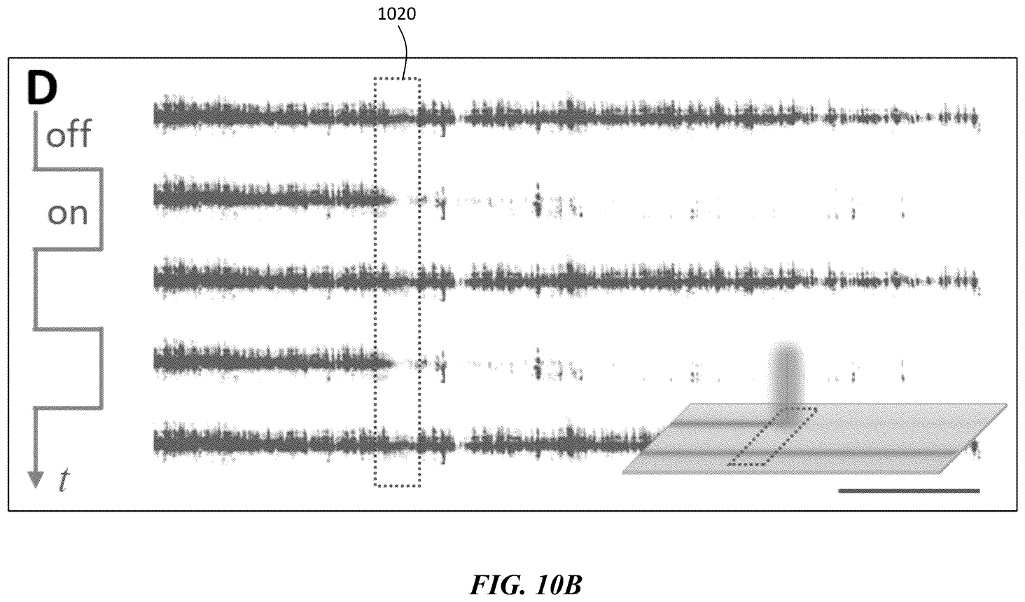

In some embodiments, the propagation of a guided mode may be modulated using external optical signals. FIG. 10A is a schematic diagram of an example of an optical device 1000 for modulation of a guided electromagnetic wave, in accordance with some embodiments of the technology described herein. The optical device 1000 is generally similar to the optical device 100, as described in connection with FIG. 1A herein, but includes the injection of a pump beam 1010 to the surface of the waveguide 110.

In some embodiments, the pump beam 1010 may be directed at the waveguide 110 along a direction perpendicular or substantially perpendicular to the surface of the waveguide 110. During operation of the optical device 1000, the laser beam 130 may be optically coupled with an edge of the waveguide 110 to generate the guided electromagnetic wave 132. The guided electromagnetic wave 132 may then, when the pump beam 1010 is turned on, encounter the pump beam 1010 and be strongly attenuated so that propagation of the guided electromagnetic wave 132 is blocked.

FIG. 10B shows dark-field microscopy images of modulated guided electromagnetic waves, in accordance with some embodiments of the technology described herein. The experimental images were acquired using light having a wavelength of 750 nm, and the scale bar indicates a length of 0.5 mm. The experimental images were also acquired using a pump beam that was a continuous wave light having a wavelength of 532 nm and intensity of approximately 2 kW/cm². The pump beam was directed at a local area of the waveguide indicated by the dotted box 1020. As shown in the dark-field microscopy images of FIG. 10B, the guided electromagnetic wave strongly attenuates when the pump beam is turned on and fully recovers its original intensity when the pump beam is turned off, modulating the intensity of the guided electromagnetic wave.

U.S. Provisional Patent Application No. 63/518,444, filed Aug. 9, 2023, titled “Wafer-Scale Waveguides for Integrated Two-Dimensional Photonics,” and U.S. Provisional Application No. 63/554,520, filed Feb. 16, 2024, titled “Wafer-Scale Waveguides for Integrated Two-Dimensional Photonics,” are each incorporated herein by reference in their entireties. M. Lee, H. Hong, J. Yu, F. Mujid, A. Ye, C. Liang, and J. Park, “Wafer-scale δ waveguides for integrated two-dimensional photonics,” Science, 381, 6658, 648-653 (2023) (DOI: 10.1126/science.adi2) and the associated Supplementary Materials are also incorporated herein by reference in their entireties.

Having thus described several aspects and embodiments of the technology set forth in the disclosure, it is to be appreciated that various alterations, modifications, and improvements will readily occur to those skilled in the art. Such alterations, modifications, and improvements are intended to be within the spirit and scope of the technology described herein. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize or be able to ascertain using no more than routine experimentation many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately,” “substantially,” and “about” may be used to mean within ±20% of a target value in some embodiments, within ±10% of a target value in some embodiments, within ±5% of a target value in some embodiments, within ±2% of a target value in some embodiments. The terms “approximately,” “substantially,” and “about” may include the target value.

What is claimed is:

1. An optical device, comprising:
a waveguide; and
an optical element disposed adjacent a surface of the waveguide such that the optical element can alter, when the optical device is in operation, an electromagnetic wave guided by the waveguide.

2. The optical device of claim 1, wherein the optical element comprises a dielectric film.

3. The optical device of claim 2, wherein the dielectric film comprises a patterned photoresist.

4. The optical device of claim 2, wherein the dielectric film comprises a prism, a convex lens, or a concave lens.

5. The optical device of claim 1, wherein the optical element comprises a metallic film.

6. The optical device of claim 5, wherein the metallic film comprises a gold film.

7. The optical device of claim 5, wherein the metallic film comprises a slit or a grating.

8. The optical device of claim 1, wherein the waveguide comprises a thin film material.

9. The optical device of claim 8, wherein the thin film material comprises at least one monolayer.

10. The optical device of claim 9, wherein the at least one monolayer comprises between one and three monolayers.

11. The optical device of claim 8, wherein the thin film material comprises a van der Waals material.

12. The optical device of claim 8, wherein the thin film material comprises a transition metal dichalcogenide.

13. The optical device of claim 12, wherein the thin film material comprises MoS₂.

14. The optical device of claim 8, wherein the optical element comprises a rectangular region of the waveguide lacking the thin film material.

15. The optical device of claim 14, wherein the rectangular region is arranged having one corner of the rectangular region disposed in a path of the electromagnetic wave guided by the waveguide.

16. The optical device of claim 1, wherein the optical element is disposed out-of-plane relative to a plane in which a surface of the waveguide is disposed.

17. A method of operating an optical device, the optical device comprising a waveguide, the method comprising:
generating a guided electromagnetic wave by:
generating a converging laser beam; and
coupling the converging laser beam to the waveguide by steering the converging laser beam towards an edge of the waveguide and with a beam center trajectory approximately parallel to a surface of the waveguide.

18. The method of claim 17, wherein generating the converging laser beam comprises generating a laser beam having a numerical aperture in a range from 0.01 to 0.6.

19. The method of claim 17, wherein generating the converging laser beam comprises generating a laser beam having a focused beam width in a range from 2 μm to 10 μm.

20. The method of claim 17, wherein generating the converging laser beam comprises generating a laser beam having a wavelength in a range from 500 nm to 900 nm.

21. The method of claim 17, wherein steering the converging laser beam towards the edge of the waveguide comprises steering the converging laser beam towards an edge of a thin film material.

22. The method of claim 21, wherein steering the converging laser beam towards the edge of a thin film material comprises steering the converging laser beam towards an edge of a thin film material comprising at least one monolayer.

23. The method of claim 21, wherein steering the converging laser beam towards the edge of the waveguide comprises steering the converging laser beam towards an edge of a thin film material comprising a van der Waals material.

24. The method of claim 21, wherein steering the converging laser beam towards the edge of the waveguide comprises steering the converging laser beam towards an edge of a thin film material comprising a transition metal dichalcogenide.
